(19) United States
(12) Patent Application Publication
(10) Pub. No.: US 2025/0251494 A1
(43) Pub. Date: Aug. 7, 2025

(54) INTEGRATION OF LIDAR SYSTEM COMPONENTS

(71) Applicant: SiLC Technologies, Inc., Monrovia, CA (US)

(72) Inventors: Mehdi Asghari, La Canada Flintridge, CA (US); Prakash Koonath, La Crescenta, CA (US); Bradley Jonathan Luff, La Canada Flintridge, CA (US)

(21) Appl. No.: 18/430,592

(22) Filed: Feb. 1, 2024

(51) Int. Cl. G01S 7/481; G02B 6/125

(52) U.S. Cl. CPC G01S 7/4814; G02B 6/125

(57) ABSTRACT

A LIDAR system has a semiconductor chip with a lateral side between the top side and the bottom side of the semiconductor chip. The lateral side includes a curved portion. The semiconductor chip also includes a slab waveguide with a facet defined by the curved portion of the lateral side of the semiconductor chip. The semiconductor chip is configured to guide outgoing LIDAR signals through the slab waveguide such that the outgoing LIDAR signal exits the slab waveguide through the curved portion of the lateral side.

### FIELD

The invention relates to imaging. In particular, the invention relates to LIDAR systems.

### BACKGROUND

Imaging systems such as LIDAR systems are being used in an increasing number of applications. LIDAR systems output a system output signal that is scanned across the field of view for the LIDAR system. An object in the field of view reflects the system output signal. A portion of the reflected system output signal returns to the LIDAR system as a system return signal. The LIDAR system uses light from the system return signal to generate LIDAR data that indicates the distance and/or radial velocity between the LIDAR system and the object.

Many LIDAR systems exchange light signals between semiconductor chips and optical components that are external to the semiconductor chip. For instance, the semiconductor chip often transmits a signal that is received by optics that collimate and/or scan the signal within the field of view of the LIDAR system. The need to combine the semiconductor chip with external components increases the size, complexity, costs, and reliability of these LIDAR systems. As a result, there is a need for LIDAR systems that can reduce or eliminate the use of the external optical components.

### SUMMARY

A LIDAR system has a semiconductor chip with a lateral side between the top side and the bottom side of the semiconductor chip. The lateral side includes a curved portion. The semiconductor chip also includes a slab waveguide with a facet defined by the curved portion of the lateral side of the semiconductor chip. The semiconductor chip is configured to direct outgoing LIDAR signals through the slab waveguide such that the outgoing LIDAR signal exits the slab waveguide through the curved portion of the lateral side.

In some instances, the semiconductor chip includes a reflecting surface configured to reflect the outgoing LIDAR signal such that the outgoing LIDAR signal travels from the reflecting surface through the slab waveguide and exits the slab waveguide through the curved portion of the lateral side. The reflecting surface can include an optical grating and the curved portion of the lateral side can be configured such that a direction that the outgoing LIDAR signal travels away from the semiconductor chip changes in response to a change in a wavelength channel carried by the outgoing LIDAR signal.

In some instances, the semiconductor chip includes a reflecting surface and multiple alternate waveguides. The reflecting surface is configured to receive the outgoing LIDAR signal from the alternate waveguides and to reflect the outgoing LIDAR signal such that the outgoing LIDAR signal travels from the reflecting surface through the slab waveguide and exits the slab waveguide through the curved portion of the lateral side. The curved portion of the lateral side can be configured such that a direction that the outgoing LIDAR signal travels away from the semiconductor chip changes in response to a change in a selection of the alternate waveguide from which the reflecting surface receives the outgoing LIDAR signal.

A LIDAR system has a semiconductor chip having slab waveguides through which light signals are transmitted. The semiconductor chip includes a lens positioned between the slab waveguides such that the light signals enter the lens from a first one of the slab waveguides and enter a second one of the slab waveguide from the lens. In some instances, the lens is in contact with a lateral side of the first slab waveguide and also in contact with a lateral side of the second slab waveguide.

### BRIEF DESCRIPTION OF THE FIGURES

FIG. 1A illustrates an imaging system that includes a chip with a photonic circuit.

FIG. 1B is an example of the operation of the imaging system of FIG. 1A.

FIG. 2 is a schematic of another embodiment of a LIDAR system.

FIG. 3 is a schematic of a suitable light source for use with the LIDAR system.

FIG. 4A through FIG. 4B illustrates an example of a light signal processor that is suitable for use as the light signal processor in a LIDAR system constructed according to FIG. 1A. FIG. 4A is a schematic of an example of a suitable optical-to-electrical assembly for use in the light signal processor.

FIG. 4B provides a schematic of the relationship between electronics and the optical-to-electrical assembly of FIG. 4A.

FIG. 4C illustrates an example of the frequency versus time pattern for a system output signal transmitted from the imaging system.

FIG. 5 is a cross section of a silicon-on-insulator wafer.

FIG. 6A is schematic of an example of a suitable signal selector having a light signal splitter and amplifiers.

FIG. 6B is schematic of another example of a suitable signal selector.

FIG. 6C is schematic of another example of a suitable signal selector.

FIG. 7A is a topview of a portion of a LIDAR chip that includes an interface for optically coupling the LIDAR chip with a signal selector.

FIG. 7B is a perspective view of a portion of the LIDAR chip shown in FIG. 7A.

FIG. 7C is a perspective view of an amplifier chip suitable for use with the portion of the LIDAR chip shown in FIG. 7A and FIG. 7B.

FIG. 7D and FIG. 7E illustrate a LIDAR system that includes the LIDAR chip of FIG. 7A and FIG. 7B interfaced with the signal selector of FIG. 7C. FIG. 7D is a topview of the system.

FIG. 7E is a cross section of the system shown in FIG. 7D taken along a line extending between the brackets labeled E in FIG. 7D.

FIG. 8A is a cross section of a LIDAR chip taken through a lens on the LIDAR chip.

FIG. 8B is a cross-section of an example waveguide.

FIG. 8C is a cross section of FIG. 8A modified so as to increase the thickness of a second light-transmitting medium.

FIG. 8D is a cross section of FIG. 8C modified such that the second light-transmitting medium is the same material as a first light-transmitting medium.

FIG. 8E is a cross section of FIG. 8A modified to include an index layer.

FIG. 8F is a cross section of FIG. 8E modified such that such that a second light-transmitting medium is the same material as a first light-transmitting medium.

FIG. 9 is a perspective view of a portion of a LIDAR chip having a curved lateral side.

### DESCRIPTION

The LIDAR system has a semiconductor chip with a lateral side between the top side and the bottom side. The lateral side includes a curved portion. The semiconductor chip also includes a slab waveguide with a facet defined by the curved portion of the lateral side of the semiconductor chip. The semiconductor chip is configured to direct outgoing LIDAR signals through the slab waveguide such that the outgoing LIDAR signal exits the slab waveguide through the curved portion of the lateral side. The curved portion of the lateral side can have a variety of shapes. For instance, the curved portion of the lateral side can be shaped as a lens that increases the collimation of the outgoing LIDAR signal.

The curved portion of the lateral side can also provide the semiconductor chip with a solid-state mechanism for steering of the outgoing LIDAR signal. For instance, the semiconductor chip can have one or more solid-state mechanisms for changing the angle of incidence of the outgoing LIDAR signal on the curved portion of the lateral side. The direction that the outgoing LIDAR signal travels away from the semiconductor chip changes as the angle of incidence changes. As a result, the semiconductor chip can scan the outgoing LIDAR signal within the LIDAR system's field of view by changing the angle of incidence of the outgoing LIDAR signal on the curved portion of the lateral side. The ability of the semiconductor chip to incorporate functionality such as collimation and/or signal scanning reduces or eliminates the use of external optical components. The reduction or elimination of external optical components reduces the costs, unreliability and complexity of the LIDAR system.

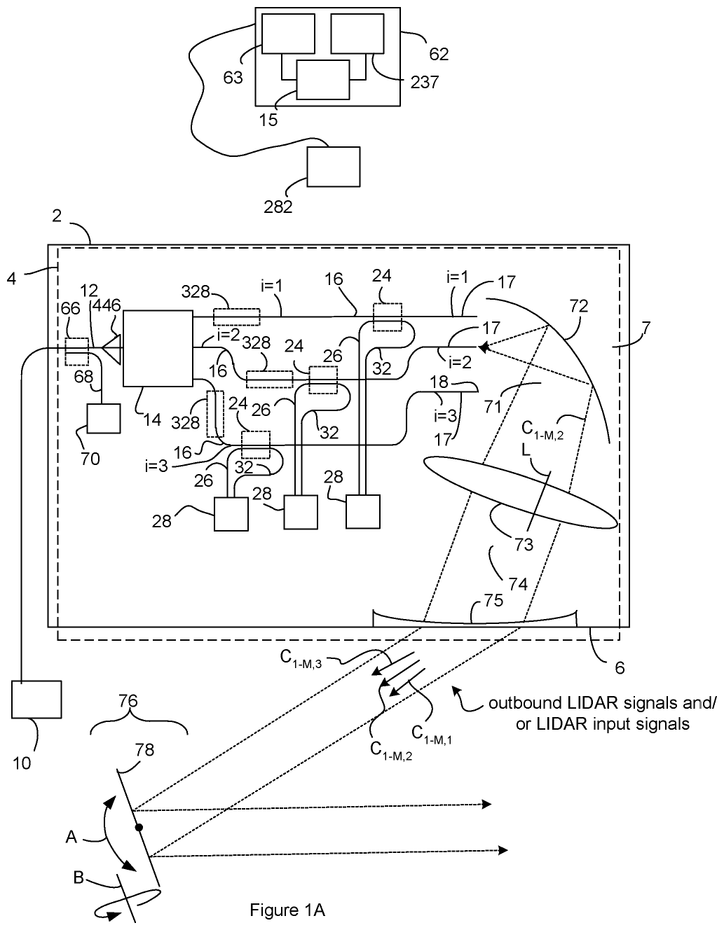

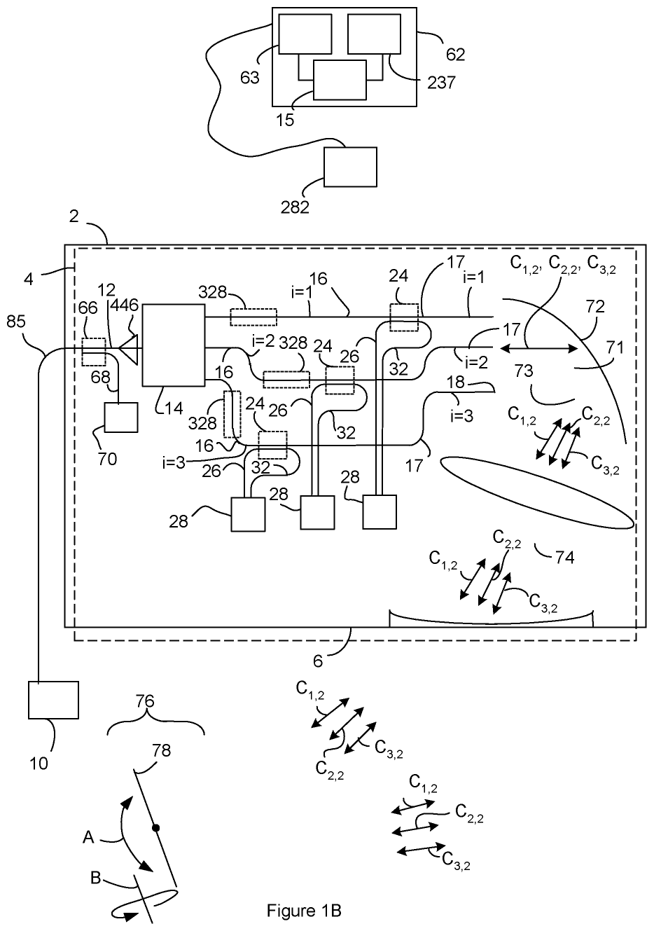

FIG. 1A is a schematic of a portion of a LIDAR system that includes a LIDAR chip such as a semiconductor chip. FIG. 1A includes a topview of a portion of the LIDAR chip 2. The LIDAR chip 2 includes a lateral side 6 between a bottom side (not shown) and the top side 7. The LIDAR system also includes a light source 10 and electronics 62. The light source 10 outputs an outgoing LIDAR signal precursor that can carry one of M different wavelength channels. There are M wavelength channels and each of the wavelength channels is associated with a wavelength channel index m where m has a value from 1 to M. Each of the M wavelength channels is at a different wavelength. The electronics 62 can operate the light source 10 so as to select which of the M different wavelength channels is carried by the outgoing LIDAR signal precursor and can switch the selection of the M different wavelength channels that are carried by the outgoing LIDAR signal precursor. In some instances, the electronics 62 operate the light source 10 such that the outgoing LIDAR signal precursor carries one, or substantially one, wavelength channel at a time. Suitable values for M include, but are not limited to, values greater than or equal to 2, 4, 8, or 16 and less than 32, 64, or 128. In some instances, the separation between adjacent wavelength channels is greater than 0.4 nm, 0.8 nm, or 1.2 nm and/or less than 5 nm, 10 nm, or 20 nm.

The LIDAR chip includes a photonic integrated circuit with a utility waveguide 12. The utility waveguide 12 receives the outgoing LIDAR signal precursor from the light source 10. The utility waveguide 12 carries the outgoing LIDAR signal precursor to a signal selector 14. The LIDAR system can include electronics 62 that operate the signal selector 14. For instance, the electronics 62 can include a selector controller 15 that operates the signal selector 14 such that the signal selector 14 outputs one or more active outgoing LIDAR signals that each includes, consists of, or consists essentially of light from the outgoing LIDAR signal precursor received by the signal selector 14. In some instances, the selector controller 15 operates the signal selector 14 such that the signal selector 14 outputs one active outgoing LIDAR signal. Each of the active outgoing LIDAR signals output by the signal selector 14 is received by a different one of multiple different alternate waveguides 16. There are N alternate waveguides and each of the alternate waveguides 16 is associated with an alternate waveguide index i where i has a value from 1 to N. Suitable values of N include, but are not limited to, values less than 128, 64, or 32 and/or greater than 2, 8, or 16. In one example, N is between 2 and 128.

Over time, each of the alternate waveguides 16 can receive an active outgoing LIDAR signal from the signal selector 14, however, the electronics can select which of the alternate waveguides receives the active outgoing LIDAR signal and can tune the selection of alternate waveguides that receive the active outgoing LIDAR signal. The alternate waveguide 16 receiving the active outgoing LIDAR signal serves as an active waveguide. Each of the alternate waveguides 16 that is not receiving an active outgoing LIDAR signal serves as an inactive active waveguide.

The active waveguide carries the active outgoing LIDAR signal to a splitter 24. The splitter 24 is configured to output a portion of the active outgoing LIDAR signal on a secondary alternate waveguide 17. Each of the secondary alternate waveguides 17 is associated with one of the alternate waveguide index i. The secondary alternate waveguides 17 associated with alternate waveguide index i receives the portion of the active outgoing LIDAR signal from the alternate waveguide associated with alternate waveguide index i. As a result, each of the secondary alternate waveguides 17 serves as a continuation of one of the alternate waveguides 16. The portion of the active outgoing LIDAR signal received by a secondary alternate waveguide 17 serves as the outgoing LIDAR signal. The secondary alternate waveguide 17 carries the outgoing LIDAR signal to a port 18 through which the active outgoing LIDAR signal can exit from the alternate waveguides 16 and serve as an outgoing LIDAR signal. Accordingly, the portion of an active outgoing LIDAR signal output from an active waveguide serves as an outgoing LIDAR signal. In some instances, the secondary alternate waveguides 17 are optional and/or not present as a result of each alternate waveguide 16 being continuous with one of the secondary alternate waveguides 17. For instance, when the splitters 24 are each a directional coupler, each alternate waveguide 16 can be continuous with one of the alternate waveguides 16 and each of the alternate waveguide 16 can provide the functionality of both an alternate waveguide 16 and a secondary alternate waveguide 17.

The light signals that result from the active outgoing LIDAR signal being received by the alternate waveguide 16 with alternate waveguide index i can be classified as light signals carrying channel (C_{m,i}) where m is the wavelength channel index and i is the alternate waveguide index. Accordingly, a light signal output from a waveguide associated with alternate waveguide index i and carrying wavelength channel m is carrying channel (C_{m,i}). As an example, the path of the outgoing LIDAR signals that carry the channel with alternate waveguide index 2 is labeled C_{1-M,2} in FIG. 1A.

The LIDAR system outputs a system output signal that includes or consists of light from the active outgoing LIDAR signal. The system output signal can be reflected by an object located outside of the LIDAR system. A portion of the system output signal reflected by the object can return to the LIDAR system as a system return signal. A LIDAR input signal includes or consists of light from the system return signal, the system output signal, and the outgoing LIDAR signal returns to the LIDAR chip such that a LIDAR input signal carrying channel C_{m,i} enters the secondary alternate waveguide 17 that is associated with the same alternate waveguide index i. As a result, LIDAR input signals carrying channels with different alternate waveguide indices are received at different secondary alternate waveguides 17. The portion of the LIDAR input signal that enters a secondary alternate waveguide 17 serves as an incoming LIDAR signal that includes or consists of light from the system return signal, the system output signal, and the outgoing LIDAR signal. As a result, the secondary alternate waveguide 17 that receives the incoming LIDAR signal can guide an active outgoing LIDAR signal while also guiding the incoming LIDAR signal in the opposite direction. Accordingly, the LIDAR system can be a monostatic system.

The secondary alternate waveguide 17 that receives the incoming LIDAR signal carries the incoming LIDAR signal to one of the splitters 24. The splitter 24 that receives the incoming LIDAR signal moves a portion of the incoming LIDAR signal from the secondary alternate waveguide 17 onto a comparative waveguide 26 as a comparative signal. The comparative signal includes light from the active outgoing LIDAR signal that has exited from the imaging system, that has been reflected by an object located outside of the imaging system, and that has returned to the imaging system. The comparative waveguide 26 carries the comparative signal to a signal processor 28 for further processing. In some instances, the splitter 24 also outputs a portion of the incoming LIDAR signal on one of the alternate waveguides 16. The portion of the incoming LIDAR signal received on the alternate waveguide 16 is generally of insufficient power to disrupt operation of the light source 10. In some instances, it may be desirable to plane an isolator on the optical path between the light source and the signal selector 14 to prevent and/or reduce interaction between the light source 10 and the portion of the incoming LIDAR signal received on the alternate waveguide 16. Suitable splitters 24 include, but are not limited to, 2×2 splitters, directional couplers such as 2×2 directional couplers, optical couplers, Y-junctions, and MMIs. In some instances, the splitter 24 is configured such that the power of the incoming LIDAR signal is divided evenly or substantially evenly between the utility waveguide 12 and the comparative waveguide 26.

As noted above, the alternate waveguide 16 associated with the same alternate waveguide index as the alternate waveguide 17 that receives the incoming LIDAR signal carries the active outgoing LIDAR signal to the splitter 24. The splitter 24 moves a portion of the active outgoing LIDAR signal from the alternate waveguide 16 onto a reference waveguide 32 as a reference signal. The reference waveguide 32 carries the reference signal to the signal processor 28 for further processing. Although not illustrated, a signal power reducer can optionally be positioned along the reference waveguide 32 to reduce the power of the reference signal to reduce or prevent saturation of one or more light sensor included in the signal processor 28. Examples of suitable signal power reducers include, but are not limited to, attenuators including variable optic attenuators (VOAs) and light splitters combined with beam dumps.

As will be described in more detail below, the signal processor 28 combines the comparative signal with the reference signal to form a composite signal that carries LIDAR data for a sample region in the field of view. Accordingly, the composite signal can be processed so as to extract LIDAR data (radial velocity and/or distance between a LIDAR system and an object external to the LIDAR system) for the sample region.

The electronics 62 can include a light source controller 63. The light source controller 63 can operate the light source such that the outgoing LIDAR signal precursor, the resulting active outgoing LIDAR signal, the resulting outgoing LIDAR signal, and the resulting system output signal, have a particular frequency versus time pattern. For instance, the light source controller 63 can operate the light source such that the outgoing LIDAR signal precursor, the resulting active outgoing LIDAR signal, and the resulting system output signal, have different chirp rates during different data periods. Additionally, or alternately, the light source controller 63 can operate the light source such that the outgoing LIDAR signal precursor, the resulting active outgoing LIDAR signal, and the resulting system output signal, carry the wavelength channel that is currently desired for operation of the LIDAR system.

The LIDAR chip can optionally include a control branch for controlling the operation of the light source 10. For instance, the control branch can provide a feedback loop that the light source controller 63 uses in operating the light source such that the outgoing LIDAR signal precursor, the resulting active outgoing LIDAR signal, and the resulting system output signal have the desired frequency versus time pattern.

The control branch includes a directional coupler 66 that moves a portion of the outgoing LIDAR signal precursor from the utility waveguide 12 onto a control waveguide 68. The coupled portion of the outgoing LIDAR signal precursor serves as a tapped signal. Although FIG. 1A illustrates a directional coupler 66 moving the portion of the outgoing LIDAR signal precursor onto the control waveguide 68, other signal-taps can be used to move a portion of the outgoing LIDAR signal precursor from the utility waveguide 12 onto the control waveguide 68. Examples of suitable signal taps include, but are not limited to, Y-junctions, and MMIs.

The control waveguide 68 carries the tapped signal to a feedback system 70. The feedback system 70 can include one or more light sensors (not shown) that convert light signals carried by the feedback system 70 to electrical signals that are output from the feedback system 70. The light source controller 63 can receive the electrical signals output from the feedback system 70. During operation, the light source controller 63 can adjust the frequency of the outgoing LIDAR signal precursor in response to output from the electrical signals output from the feedback system 70. An example of a suitable construction and operation of feedback system 70 and light source controller 63 is provided in U.S. patent application Ser. No. 16/875,987, filed on 16 May 2020, entitled “Monitoring Signal Chirp in Outbound LIDAR signals,” and incorporated herein in its entirety; and also in U.S. patent application Ser. No. 17/244,869, filed on 29 Apr. 2021, entitled “Reducing Size of LIDAR System Control Assemblies,” and incorporated herein in its entirety.

Although FIG. 1A illustrates the electronics 62 as a component that is separate from the signal processor(s) 28, a portion of the electronics 62 can be included in each of the signal processor(s) 28.

The portion of the LIDAR system illustrated in FIG. 1A includes a reflecting surface 72 that receives the outgoing LIDAR signals output from the selection of secondary alternate waveguides 17. For instance, the LIDAR chip includes a free space region 71 that extends from the reflecting surface 72 to the secondary alternate waveguides 17 and from a lens 73 to the reflecting surface 72 and/or the secondary alternate waveguides 17. As illustrated by the outgoing LIDAR signal labeled C_{1-M,2}, the one or more outgoing LIDAR signals travel through the free space region 71 between the secondary alternate waveguides 17 and the reflecting surface 72 and/or between the reflecting surface 72 and an optional lens 73 included on the LIDAR chip. For instance, the outgoing LIDAR signals can travel from the secondary alternate waveguides 17, through the free space region 71 to the reflecting surface 72 and then from the reflecting surface 72 to the lens 73.

The LIDAR chip can also include a second free space region 74 that extends from the lens 73 to a facet 75 at the lateral side 6 of the LIDAR chip. The lateral side of the chip can serve as the facet of the second free space region 74. The one or more outgoing LIDAR signals can exit the lens 73 and can travel through the second free space region 74 to the lens 73 at the lateral side of the LIDAR chip. The one or more outgoing LIDAR signals can exit the LIDAR chip through the facet 75. The portion of each outgoing LIDAR signal that exits the LIDAR chip through the facet 75 can serve as an outbound LIDAR signal. The reflecting surface 72 can configured such that the LIDAR output signals travel away from the semiconductor chip in different directions.

Additionally, or alternately, the incoming LIDAR signals also travel through the free space region 71 and the second free space region 74. For instance, the incoming LIDAR signals can travel through the second free space region 74 from the facet 75 to the lens 73. The incoming LIDAR signals can exit the lens 73 and travel through the free space region 71 from the lens 73 to the reflecting surface 72 and from the reflecting surface 72 to the secondary alternate waveguides 17.

In some instances, the free space region 71 and/or the second free space region 74 are free space in the horizontal direction but guided in the vertical direction and can accordingly be considered a partially free space region 71. As a result, the outgoing LIDAR signals and/or the incoming LIDAR signals can contract or expand horizontally when traveling through the free space region 71 and/or the second free space region 74. Accordingly, the free space region 71 and/or the second free space region 74 can be slab waveguides. The horizontal direction and the vertical direction can be measured relative to a plane of the LIDAR chip. An example of the plane of the LIDAR chip can be the bottom of the LIDAR chip or other surface of the LIDAR chip that is considered or approximates a horizontal surface.

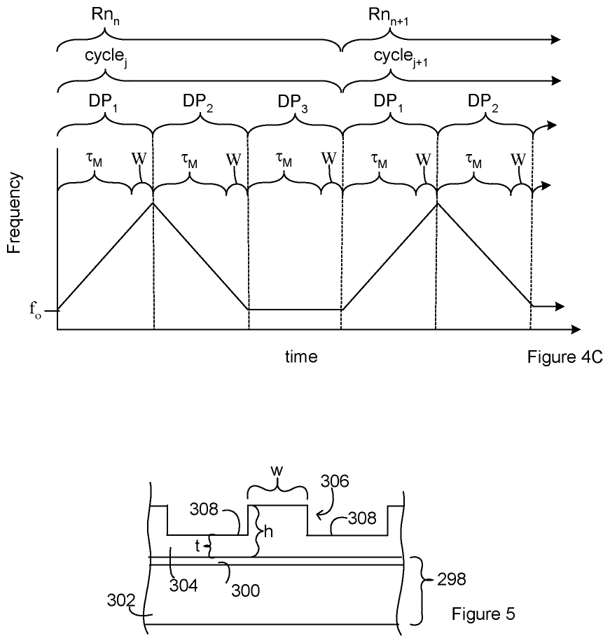

In some instances, the shape of the reflecting surface 72 is selected to provide collimation or focusing of the outgoing LIDAR signals and accordingly of the resulting outbound LIDAR signals. The collimation provided by the reflecting surface 72 can be in a plane that is parallel to a plane of the LIDAR chip as shown in FIG. 4A without providing substantial collimation within a plane perpendicular to the plane of the LIDAR chip. Additionally, or alternately, the shape of the reflecting surface 72 can be selected to focus the incoming LIDAR signals on the secondary alternate waveguides 17. The focus provided by the reflecting surface 72 can be in a plane that is parallel to a first plane without providing substantial collimation within a second plane that is perpendicular to the first plane. The first plane can be the plane of the LIDAR chip.

In some instances, the reflecting surface 72 is a smooth and curved surface that acts as a mirror. In some instances, the reflecting surface 72 is configured as a reflective optical grating such an echelle grating. In one example, the reflecting surface 72 is parabolic, spherical, or aspherical and can be optimized to achieve the desired light throughput. In one example, the reflecting surface 72 is substantially parabolic or approximately parabolic. The interface between the free space region 71, the secondary alternate waveguides 17, the reflecting surface 72 can be constructed and as disclosed in U.S. patent application Ser. No. 18/383,037, filed on Oct. 23, 2023, entitled “Return Surfaces in LIDAR Systems,” and incorporated herein in its entirety.

The lens 73 can be configured to increase the collimation of the outgoing LIDAR signals. In some instances, the facet 75 can provide refraction of the outgoing LIDAR signals. The facet can be curved so as to increase the collimation of the outbound LIDAR signals relative to the level of collimation in the outgoing LIDAR signal that was the source of the outbound LIDAR signal. For instance, the facet can be curved such that the refraction provides collimation or substantial collimation of the outbound LIDAR signals. When the LIDAR system includes the lens 73 and the lens is configured to increase the collimation of the outbound LIDAR signals, any collimation provided by the facet 75 can be in addition to the collimation of the outbound LIDAR signals provided by the lens 73. For instance, the collimation provided by the facet 75 can correct for errors in the collimation provided by the lens 73.

The illustrated facet 75 acts as a convex lens in that the facet 75 is curved outward from the body of the LIDAR chip. However, the facet 75 can have other configurations. For instance, the facet 75 can be curved inward toward the body of the LIDAR chip.

The LIDAR system optionally includes an optical component assembly 76 that receives the outbound LIDAR signals from the LIDAR chip and outputs system output signals that each includes, consists of, or consists essentially of light from a different one of the outbound LIDAR signals. When the optical assembly includes active components such as movable mirrors, the electronics 62 can include assembly electronics 280 configured to operate the active components so as to steer the system output signals to different sample regions in the LIDAR system's field of view.

An optical component assembly 76 can optionally include one or more scanners 78. For instance, FIG. 1A illustrates an optical component assembly 76 that includes a scanner 78 that receives the outbound LIDAR signals output from the LIDAR. The portion of the outbound LIDAR signal output from the scanner 78 serves as the system output signals for the LIDAR system. The electronics can include assembly electronics 280 that operate the one or more scanners 78 so as to steer each of the system output signal to different sample regions in the field of view.

The one or more scanners 78 can be configured such that the electronics can steer the system output signals in one dimension or in two dimensions. As a result, the one or more scanners 78 can function as a beam-steering mechanism that is operated by the electronics so as to steer the system output signals within the field of view of the LIDAR system. Accordingly, the one or more system output signals output by the LIDAR system can be steered within the LIDAR system's field of view by operating the one or more scanners 78 in combination with switching the wavelength channel carried by all or a portion of the system output signals and/or switching the selection of secondary alternate waveguides that output the system output signals.

Suitable scanners 78 include, but are not limited to, movable mirrors, polygon mirror, MEMS mirrors, optical phased arrays (OPAs), optical gratings, and actuated optical gratings. In some instances, the lens 73, facet 75, and/or the one or more scanners 78 are configured to operate on the outbound LIDAR signals such that the system output signals are collimated or substantially collimated as they travel away from the LIDAR system.

When the reflecting surface 72 acts as a mirror or includes a reflective grating, the lines labels C_{1-M,1}, C_{1-M,2}, and C_{1-M,3} in FIG. 1A can represent the central rays of outgoing LIDAR signals that originate from different alternate waveguides and/or outbound LIDAR signals that originate from different alternate waveguides. All or a portion of the central rays of outgoing LIDAR signals and/or outbound LIDAR signals that originate from different alternate waveguides can each be incident on the lens 73 and/or the facet 75 at a different angle of incidence. As a result, the signal selector 14 can serve as a solid-state mechanism for changing the angle of incidence of the outgoing LIDAR signal. The change in the angles of incidence can cause outgoing LIDAR signals from different alternate waveguides to travel away from the lens 73 in different directions and can cause outbound LIDAR signals from different alternate waveguides to travel away from the LIDAR chip in different directions. The resulting system output signals also travel away from the LIDAR system in different directions. As a result, the system output signals can be steered within the LIDAR system's field of view by operating the signal selector 14 so as change the selection of alternate waveguides 16 that receive the active outgoing LIDAR signal.

When the reflecting surface 72 includes an optical grating, the reflecting surface 72 causes the wavelength channels represented by the indices 1-M to separate as they travel away from the reflecting surface 72. Accordingly, each of the different outgoing LIDAR signals and/or outbound LIDAR signals can be represented by C_{m,i} with a different combination of values for the wavelength channel index (m) and alternate waveguide index (i). As an example, FIG. 1B illustrates the LIDAR system of FIG. 1A modified such that the central rays of the outgoing LIDAR signals labeled C_{1-M,2} in FIG. 1A are shown separating into the outgoing LIDAR signals and outbound LIDAR signals labeled C_{1,2}, C_{2,2}, and C_{3,2}. As is evident from FIG. 1B, all or a portion of the central rays from outgoing LIDAR signals that originate from the same alternate waveguide carrying different wavelength channels can each be incident on the lens 73 and/or the facet 75 at a different angle of incidence. As a result, the light source can serve as a solid-state mechanism for changing the angle of incidence of the outgoing LIDAR signal. The change in the angle of incidence can cause outbound LIDAR signals that originate from the same alternate waveguide carrying different wavelength channels to travel away from the LIDAR chip in different directions. The resulting system output signals also travel away from the LIDAR system in different directions. As a result, the system output signals can be steered within the LIDAR system's field of view by operating the light source 10 so as change the wavelength channel carried by the outgoing LIDAR signal and the resulting system output signal.

The above description illustrates that there are multiple scanning mechanisms that can be employed to scan the system output signals output from the LIDAR system. Accordingly, the LIDAR system can scan the system output signals by one, two, or three or mechanisms selected from the group consisting of changing the wavelength channel carried by the outgoing LIDAR signal and the resulting system output signal, changing the selection of secondary alternate waveguides that receive the active outgoing LIDAR signal, changing the selection of alternate waveguides that receive the active outgoing LIDAR signal, and operation of the one or more scanners 78. In one example, the LIDAR system changing the wavelength channel carried by the outgoing LIDAR signal and changing the selection of alternate waveguides that receive the active outgoing LIDAR signal scans the system output signal within a plane or substantially within a plane and one or more of the scanners 78 are operated so as to scan the system perpendicular or substantially perpendicular to the plane.

The system output signals can be reflected by an object located outside of the LIDAR system. All or a portion of the reflected light from a system output signal can return to the LIDAR system as a system return signal. When the LIDAR system includes one or more scanners 78, each of the system return signals is received at the one or more scanners 78. The one or more scanners 78 output at least a portion of each of the system return signals. A portion of each system return signal output from the one or more scanners 78 can enter the LIDAR chip. When the LIDAR system excludes scanners 78, each of the system return signals can enter the LIDAR chip. The portion of each system return signal that enters the LIDAR chip can serve as a LIDAR input signal.

The LIDAR input signals are received at the facet 75 and can enter the LIDAR chip through the facet 75. The LIDAR input signals travel through the second free space region 74 to the lens 73. The LIDAR input signals output from the lens 73 travel through the free space region 71 to the alter0eguides 16. Each of the different LIDAR input signals is received by one of the alternate waveguides such that the LIDAR input signal received at an alternate waveguide includes or consists of the light from the outbound LIDAR signal and system output signal that was output from the same alternate waveguide.

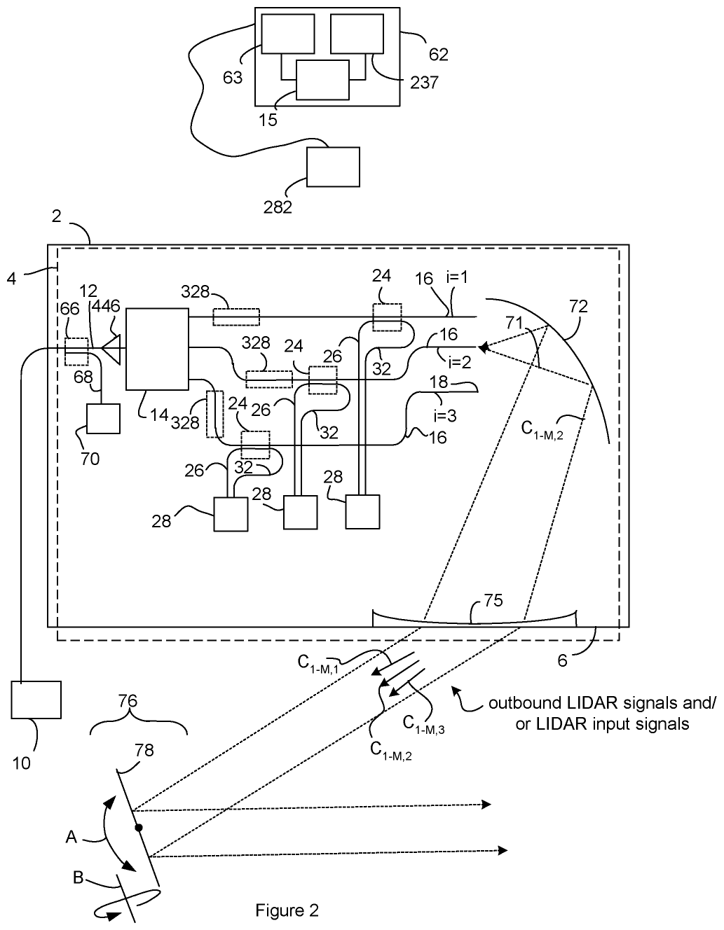

The lens 73 is optional. For instance, FIG. 2 illustrates the LIDAR system of FIG. 1A modified to exclude the lens 73 shown in FIG. 1A. The free space region 71 extends from the reflecting surface 72 to the alternate waveguides 16 and from facet 75 to the reflecting surface 72 and/or the alternate waveguides 16. As illustrated by the outgoing LIDAR signal labeled C_{1-M,2}, the one or more outgoing LIDAR signals travel through the free space region 71 between the alternate waveguides 16 and the reflecting surface 72 and/or between the reflecting surface 72 and the facet 75. The one or more outgoing LIDAR signals can exit the LIDAR chip through the facet 75. The portion of each outgoing LIDAR signal that exits the LIDAR chip through the facet 75 can serve as an outbound LIDAR signal. The reflecting surface 72 can configured such that the LIDAR output signals travel away from the semiconductor chip in different directions. Additionally, or alternately, the incoming LIDAR signals also travel through the free space region 71. For instance, the incoming LIDAR signals can travel through the free space region 71 from the facet 75 to the reflecting surface 72 and from the reflecting surface 72 to the alternate waveguides 16.

In some instances, the free space region 71 is a free space in the horizontal direction but guided in the vertical direction and can accordingly be considered a partially free space region 71. As a result, the outgoing LIDAR signals and/or the incoming LIDAR signals can contract or expand horizontally when traveling through the free space region 71. Accordingly, the free space region 71 can be a slab waveguides. The horizontal direction and the vertical direction can be measured relative to a plane of the LIDAR chip. An example of the plane of the LIDAR chip can be the bottom of the LIDAR chip or other surface of the LIDAR chip that is considered or approximates a horizontal surface.

In some instances, the shape of the reflecting surface 72 is selected to provide collimation or focusing of the outgoing LIDAR signals and accordingly of the resulting outbound LIDAR signals. The collimation provided by the reflecting surface 72 can be in collimation can be in a plane that is parallel to a plane of the LIDAR chip without providing substantial collimation within a plane perpendicular to the plane of the LIDAR chip. Additionally, or alternately, the shape of the reflecting surface 72 can be selected to focus the incoming LIDAR signals on the alternate waveguides 16. The focus provided by the reflecting surface 72 can be in a plane that is parallel to the first plane without providing substantial collimation within a second plane that is perpendicular to the first plane. The first plane can be the plane of the LIDAR chip.

In some instances, the reflecting surface 72 is a smooth and curved surface that acts as a mirror. In some instances, the reflecting surface 72 is configured as a reflective optical grating such an echelle grating. In one example, the reflecting surface 72 is parabolic, spherical, or aspherical and can be optimized to achieve the desired light throughput. In one example, the reflecting surface 72 is substantially parabolic or approximately parabolic. The interface between the free space region 71, the alternate waveguides 16, the reflecting surface 72 can be constructed and as disclosed in U.S. patent application Ser. No. 18/383,037, filed on Oct. 23, 2023, entitled “Return Surfaces in LIDAR Systems,” and incorporated herein in its entirety.

In some instances, the facet 75 can provide refraction of the outgoing LIDAR signals. The facet 75 can be curved so as to increase the collimation of the outgoing LIDAR signals. For instance, the facet can be curved such that the refraction provides collimation of the outgoing LIDAR signals.

The illustrated facet 75 acts as lens such as a convex lens in that the facet 75 is curved outward from the body of the LIDAR chip. However, the facet 75 can have other configurations. For instance, the facet 75 can be curved inward toward the body of the LIDAR chip.

The system output signals can be reflected by an object located outside of the LIDAR system. All or a portion of the reflected light from a system output signal can return to the LIDAR system as a system return signal. When the LIDAR system includes one or more scanners 78, each of the system return signals is received at the one or more scanners 78. The one or more scanners 78 output at least a portion of each of the system return signals. A portion of each system return signal output from the one or more scanners 78 can enter the LIDAR chip. When the LIDAR system excludes scanners 78, each of the system return signals can enter the LIDAR chip. The portion of each system return signal that enters the LIDAR chip and serves as a LIDAR input signal.

The LIDAR input signals are received at the facet 75 and can enter the LIDAR chip through the facet 75. The LIDAR input signals travel through the second free space region 74 to the lens 73. The LIDAR input signals output from the lens 73 travel through the free space region 71 to the alternate waveguides 16. Each of the different LIDAR input signals is received by one of the alternate waveguides such that the LIDAR input signal received at an alternate waveguide includes or consists of the light from the outbound LIDAR signal and system output signal that was output from the same alternate waveguide.

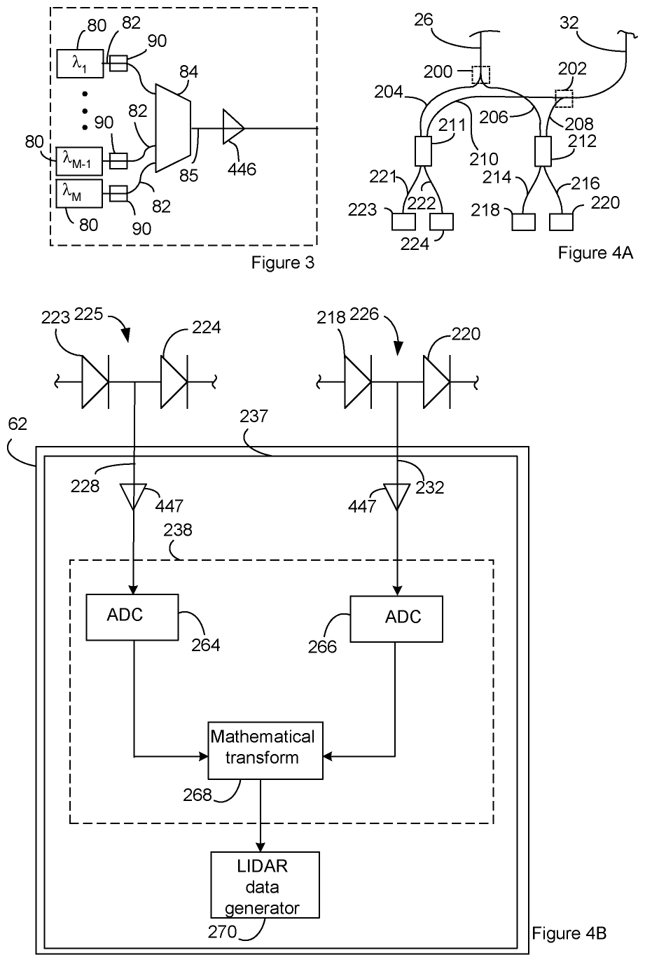

Although the light source 10 is shown as being positioned off the LIDAR chip, all or a portion of the light source 10 can be located on the LIDAR chip. FIG. 3 illustrates an example of a light source 10 suitable for used in conjunction with the LIDAR system. The light source 10 includes multiple laser sources 80. Each of the laser sources 80 is configured to output a wavelength channel signal on a source waveguide 82. Each wavelength channel signal can carry one of the m=1-M wavelength channels. For instance, FIG. 3 illustrates one possible arrangement where the source waveguide 82 that guides the wavelength channel signal carrying wavelength channel m is labeled □ₘ where m represents the wavelength channel index, and the wavelength channel(s) are each associated with wavelength channel index m=1 through m=M.

Each of the source waveguides 82 carries a wavelength channel signal to a signal mixer 84 that combines the wavelength channel signals so as to form a light signal that is received on a channel waveguide 85. The light signal mixer 84 can be a wavelength dependent multiplexer including, but not limited to, an Arrayed Waveguide Grating (AWG) multiplexer, and an echelle grating multiplexer. The light signal mixer 84 can also be a wavelength independent mixer including, but not limited to, cascaded Y-junctions, cascaded MMI splitters, and a star coupler.

The portion of the light signal received by a channel waveguide 85 can serve as the outgoing LIDAR signal predecessor. The channel waveguide 85 carries the outgoing LIDAR signal predecessor to the utility waveguide 12 or can serve as the utility waveguide 12. The portion of the outgoing LIDAR signal predecessor received by a utility waveguide 12 serves as the outgoing LIDAR signal precursor received by the utility waveguide 12.

An outgoing LIDAR signal precursor, the resulting active outgoing LIDAR signal, the resulting outbound LIDAR signal, and the system output signal each carries light from one of the wavelength channel signals. Since each of the wavelength channel signals carries one of the wavelength channels, the electronics can operate the light source 10 such that the outgoing LIDAR signal precursors received by the utility waveguide 12 carries one of the wavelength channels. For instance, the electronics can operate the laser sources 80 independently such that only one of the laser sources 80 outputs a wavelength channel signal while the other laser sources 80 do not output a wavelength channel signal. As an example, the electronics can turn on the laser sources 80 that outputs the desired wavelength channel signal and turn off the source(s) 80 that do not output the desired wavelength channel signal. When the laser sources 80 are each a gain element or laser chip, the light source controller 63 can apply an electrical current through the gain element or laser cavity in one of the laser sources 80 so as to cause that laser source to output a wavelength channel signal while refraining from applying an electrical current through the gain element or laser cavity in the one or more remaining laser source(s) 80 so they do not output a wavelength channel signal. As a result, the outgoing LIDAR signal precursor received by the utility waveguide 12 carries one of the wavelength channels. The electronics can also operate the laser source(s) 80 so as to change the wavelength channel that is present in the outgoing LIDAR signal precursor. For instance, the light source controller 63 can change the laser source to which the electrical current is applied. The light source to which the electrical current is applied can be the light source that outputs the wavelength channel signal that carries the wavelength channel that is currently desired for the outgoing LIDAR signal precursors and accordingly the resulting system output signals.

The light source 10 can optionally include one or more modulators 90 that are each positioned so as to modulate one of the wavelength channel signals. For instance, the light source 10 can optionally include one or more modulators 90 positioned along each of the source waveguides 82. The light source controller 63 can operate each of the modulators 90 so as to allow a wavelength channel signal carried in a source waveguide 82 to pass the modulator 90 without attenuation from the modulator or such that the wavelength channel signal carried in a source waveguide 82 is attenuated by the modulator. The attenuation can be sufficient that the attenuated wavelength channel is not substantially present in the channel waveguide 85. As a result, the attenuation can be sufficient that the attenuated wavelength channel is not substantially present in the outgoing LIDAR signal precursors output from the light source and is accordingly not substantially present in the system output signals output from the LIDAR system. As a result, an alternative to the light source controller 63 turning laser sources 80 on and off so as to select the wavelength channel carried in the system output signals, the light source controller 63 can keep the laser sources that generate the needed channel wavelengths “on” and also operate the one or more modulators 90 so the outgoing LIDAR signal precursors carry the currently desired wavelength channel. Accordingly, the light source controller 63 can keep the laser sources that generate the channel wavelengths that will be needed “on” while operating the one or more modulators 90 so the system output signal(s) carry the currently desired wavelength channel. As an example, when it is desired for the outgoing LIDAR signal precursors and system output signals to carry wavelength channel 12, the source controller 63 can operate laser sources 80 that generate channel wavelengths 11-IM such that each of these laser sources 80 concurrently outputs a wavelength channel signal and can operate the modulators 90 such that the wavelength channel signal that carries wavelength channel 12 passes the associate modulator 90 but the wavelength channel signals carrying 11 and 13 through IM are attenuated such that wavelength channels 11 and wavelength channels 13 through IM are not substantially present in the resulting outgoing LIDAR signal precursors and are accordingly not substantially present in the resulting outgoing LIDAR signal precursors and in the resulting system output signals. Suitable modulators 90 include, but are not limited to, Variable Optical Attenuators (VOAs), Mach-Zehnder modulators. An example of a suitable optical attenuator can be found in U.S. patent application Ser. No. 17/396,616, filed on Aug. 6, 2021, entitled “Carrier Injector Having Increased Compatibility,” and incorporated herein in its entirety.

When a light source 10 is constructed as shown in FIG. 3, each of the outgoing LIDAR signal precursors, the resulting active outgoing LIDAR signals and system output signals concurrently carries the same wavelength channel, however, other light source configurations are possible.

Suitable waveguides for use as the source waveguide 82, channel waveguide 85, and/or the core waveguides 87 include, but are not limited to optical fibers and planar optical waveguides. Although FIG. 3 illustrates the light source 10 as separate from the LIDAR chip, all or a portion of the light source 10 can be positioned on the LIDAR chip and/or integrated into the LIDAR chip. As a result, suitable waveguides for use as the source waveguide 82 and/or channel waveguide 85 include, but are not limited to rib waveguides, ridge waveguides, buried waveguides.

FIG. 4A through FIG. 4B illustrates an example of a light signal processor that is suitable for use as the light signal processor 28 in a LIDAR system constructed according to FIG. 1A. The light signal processor includes an optical-to-electrical assembly configured to convert the light signals to electrical signals. FIG. 4A is a schematic of an example of a suitable optical-to-electrical assembly that includes a first splitter 200 that divides the comparative signal received from the comparative waveguide 26 onto a first comparative waveguide 204 and a second comparative waveguide 206. The first comparative waveguide 204 carries a first portion of the comparative signal to a light combiner 211. The second comparative waveguide 206 carries a second portion of the comparative signal to a second light combiner 212.

The light signal processor of FIG. 4A also includes a second splitter 202 that divides the reference signal received from the reference waveguide 32 onto a first reference waveguide 210 and a second reference waveguide 208. The first reference waveguide 210 carries a first portion of the reference signal to the light combiner 211. The second reference waveguide 208 carries a second portion of the reference signal to the second light combiner 212.

The second light combiner 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal. The first composite signal and the second composite signal are each an example of a composite signal.

The second light combiner 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include germanium photodiodes (PDs), and avalanche photodiodes (APDs).

In some instances, the second light combiner 212 splits the second composite signal such that the portion of the comparative signal (i.e. the portion of the second portion of the comparative signal) included in the first portion of the second composite signal is phase shifted by 180° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second light combiner 212 splits the second composite signal such that the portion of the reference signal (i.e. the portion of the second portion of the reference signal) in the first portion of the second composite signal is phase shifted by 180° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include germanium photodiodes (PDs), and avalanche photodiodes (APDs).

The first light combiner 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The light combiner 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second light sensor 224 that converts the second portion of the second composite signal to a second electrical signal. Examples of suitable light sensors include germanium photodiodes (PDs), and avalanche photodiodes (APDs).

In some instances, the light combiner 211 splits the first composite signal such that the portion of the comparative signal (i.e. the portion of the first portion of the comparative signal) included in the first portion of the composite signal is phase shifted by 180° relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the light combiner 211 splits the composite signal such that the portion of the reference signal (i.e. the portion of the first portion of the reference signal) in the first portion of the composite signal is phase shifted by 180° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second light combiner 212 splits the second composite signal such that the portion of the comparative signal in the first portion of the second composite signal is phase shifted by 180° relative to the portion of the comparative signal in the second portion of the second composite signal, the light combiner 211 also splits the composite signal such that the portion of the comparative signal in the first portion of the composite signal is phase shifted by 180° relative to the portion of the comparative signal in the second portion of the composite signal. When the second light combiner 212 splits the second composite signal such that the portion of the reference signal in the first portion of the second composite signal is phase shifted by 180° relative to the portion of the reference signal in the second portion of the second composite signal, the light combiner 211 also splits the composite signal such that the portion of the reference signal in the first portion of the composite signal is phase shifted by 180° relative to the portion of the reference signal in the second portion of the composite signal.

The first reference waveguide 210 and the second reference waveguide 208 are constructed to provide a phase shift between the first portion of the reference signal and the second portion of the reference signal. For instance, the first reference waveguide 210 and the second reference waveguide 208 can be constructed so as to provide a 90-degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 210 and the second reference waveguide 208 are constructed such that the first reference signal portion is a cosine function, and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

The first light sensor 223 and the second light sensor 224 can be connected as a balanced detector and the first auxiliary light sensor 218 and the second auxiliary light sensor 220 can also be connected as a balanced detector. The balanced detector(s) serve as light sensors that convert a light signal to an electrical signal. FIG. 4B provides a schematic of the relationship between the electronics 62 and one of the light signal processors 28. For instance, FIG. 4B provides a schematic of the relationship between the electronics 62 and the first light sensor 223, the second light sensor 224, the first auxiliary light sensor 218, and the second auxiliary light sensor 220 from the same light signal processor. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 4B are included on the LIDAR chip. In some instances, the components illustrated in the schematic of FIG. 4B are distributed between the LIDAR chip and electronics located off the LIDAR chip.

The electronics 62 connect the first light sensor 223 and the second light sensor 224 as a first balanced detector 225 and the first auxiliary light sensor 218 and the second auxiliary light sensor 220 as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal. The first data line and the second data line are each an example of a data line. The first data signal is an electrical data signal that carries a representation of the first composite signal and the second data signal is an electrical data signal that carries a representation of the second composite signal. Accordingly, the first data signal includes a contribution from a first waveform and a second waveform, and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e., the beating in the first composite signal and in the second composite signal.

The electronics 62 include a data processor 237 configured to generate the LIDAR data. For the purposes of illustration, FIG. 4B illustrates one data processor in the electronics 62, however, the electronics 62 for a core can include a data processor 237 for each light signal processor 28 operated by the electronics 62.

The data processor 237 includes a beat frequency identifier 238 configured to identify the beat frequency of the composite signal from the first data signal and the second data signal. The beat frequency identifier 238 receives the first data signal and the second data signal. Since the first data signal is an in-phase component and the second data signal its quadrature component, the first data signal and the second data signal together act as a complex data signal where the first data signal is the real component, and the second data signal is the imaginary component of the complex data signal.

The data processor 237 includes a first Analog-to-Digital Converter (ADC) 264 that receives the first data signal from the first data line 228. The first Analog-to-Digital Converter (ADC) 264 converts the first data signal from an analog form to a digital form and outputs a first digital data signal. The beat frequency identifier 238 includes a second Analog-to-Digital Converter (ADC) 266 that receives the second data signal from the second data line 232. The second Analog-to-Digital Converter (ADC) 266 converts the second data signal from an analog form to a digital form and outputs a second digital data signal. The first digital data signal is a digital representation of the first data signal and the second digital data signal is a digital representation of the second data signal. Accordingly, the first digital data signal and the second digital data signal act together as a complex signal where the first digital data signal acts as the real component of the complex signal and the second digital data signal acts as the imaginary component of the complex data signal.

The beat frequency identifier 238 includes a mathematical transformer 268 that receives the complex data signal. For instance, the mathematical transformer 268 receives the first digital data signal from the first Analog-to-Digital Converter (ADC) 264 as an input and also receives the second digital data signal from the first Analog-to-Digital Converter (ADC) 266 as an input. The mathematical transformer 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of a comparative signal relative to the system output signal.

The mathematical transformer 268 can include a peak finder (not shown) configured to identify peaks in the output of the mathematical transformer 268. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal.

The data processor 237 includes a LIDAR data generator 270 that receives the beat frequency of the composite signal from the peak finder. The LIDAR data generator 270 processes the beat frequency of the composite signal so as to generate the LIDAR data (distance and/or radial velocity between the reflecting object and the LIDAR chip or LIDAR system). The transform component 268 can execute the attributed functions using firmware, hardware or software or a combination thereof.

The light source controller 63 operates the light source 10 such that the outbound LIDAR signal and the resulting system output signal have a frequency versus time pattern. For instance, when a light source is constructed according to FIG. 3 and the laser sources include a gain element or laser chip, the light source controller 63 can change the frequency of the outgoing LIDAR signal precursor and the resulting active outgoing LIDAR signal by changing the level of electrical current applied through the gain element or laser cavity. Additionally, or alternately, the light source 10 can include one or more modulators (not shown) that the light source controller 63 can use to modulate the frequency of the outgoing LIDAR signal precursor and the resulting active outgoing LIDAR signal. When the light source 10 includes a modulator one or more, the light source controller 63 can operate the modulator so as to achieve the desired frequency versus time pattern in light signals that include light from the outgoing LIDAR signal precursor and the resulting active outgoing LIDAR signal. The light source controller 63 can execute the attributed functions using firmware, hardware or software or a combination thereof.

FIG. 4C shows an example of a chirp pattern for the outgoing LIDAR signal precursors the resulting active outgoing LIDAR signals, outbound LIDAR signals and the resulting system output signals. FIG. 4C shows an example of a relationship between the frequency of the system output signals, time, cycles, periods and sample regions. The base frequency of the system output signal (fₒ) can be the frequency of the system output signal at the start of a cycle. The frequency versus time pattern shown in FIG. 4C can represent the frequency versus time pattern for the system output signals that are concurrently output from the LIDAR system carrying the same wavelength channel. However, different system output signals that carry the same wavelength channel illuminate a different selection of sample regions. Since FIG. 4C applies to a set of sample regions labeled Rnₙ and Rnₙ₊₁, the disclosure of FIG. 4C applies to the system output signal that illuminates these sample regions. Additionally, the frequency versus time pattern shown in FIG. 4C is for system output signals carrying a particular one of the wavelength channels. When the wavelength channel is switched, the system output signals can have the same pattern but at the wavelength of the new wavelength channel. Accordingly, the frequency versus time pattern shown in FIG. 4C will be shifted upward or downward in response to the change in wavelength channel.

FIG. 4C shows frequency versus time for a sequence of two cycles labeled cycleⱼ and cycleⱼ₊₁. In some instances, the frequency versus time pattern is repeated in each cycle as shown in FIG. 4C. The illustrated cycles do not include re-location periods and/or re-location periods are not located between cycles. As a result, FIG. 4C illustrates the results for a continuous scan where the steering of the system output signal is continuous.

Each cycle includes multiple data periods labeled DP₁, DP₂, and DP₃. In some instances, the frequency versus time pattern is the same for the data periods that correspond to each other in different cycles as is shown in FIG. 4C. Corresponding data periods are data periods with the same period index. As a result, each data period DP₁ can be considered corresponding data periods and the associated frequency versus time patterns are the same in FIG. 4C. At the end of a cycle, the electronics return the frequency to the same frequency level at which it started the previous cycle.

During the data periods DP₁ the electronics operate the light source such that the frequency of the system output signal changes at a linear rate □. During the data periods DP₂ the electronics operate the light source such that the frequency of the system output signal changes at a linear rate −□.

FIG. 4C labels sample regions that are each associated with a sample region index n and are labeled Rnₙ. FIG. 4C labels sample regions Rnₖ and Rnₖ₊₁. Each sample region is illuminated with the system output signal during the data periods that FIG. 4C shows as associated with the sample region. For instance, sample region Rnₙ is illuminated with the system output signal during the data periods labeled DP₁ through DP₃. The sample region indices n can be assigned relative to time. For instance, the sample regions can be illuminated by the system output signal in the sequence indicated by the index n. As a result, the sample region Rn₁₀ can be illuminated after sample region Rn₉ and before Rn₁₁.

The LIDAR system is typically configured to provide reliable LIDAR data when the object is within an operational distance range from the LIDAR system. The operational distance range can extend from a minimum operational distance to a maximum operational distance. A maximum roundtrip time can be the time required for a system output signal to exit the LIDAR system, travel the maximum operational distance to the object, and to return to the LIDAR system and is labeled □_{M} in FIG. 4C.

Since there is a delay between the system output signal being transmitted and returning to the LIDAR system, the composite signals do not include a contribution from the LIDAR signal until after the system return signal has returned to the LIDAR system. Since the composite signal needs the contribution from the system return signal for there to be a LIDAR beat frequency, the electronics measure the LIDAR beat frequency that results from system return signal that return to the LIDAR system during a data window in the data period. The data window is labeled “W” in FIG. 4C. The contribution from the LIDAR signal to the composite signals will be present at times larger than the maximum operational time delay (□_{M}). As a result, the data window is shown extending from the maximum operational time delay (□_{M}) to the end of the data period.

A frequency peak in the output from a mathematical transform such as a Complex Fourier transform represents the beat frequency of the composite signals that each includes a comparative signal beating against a reference signal. The beat frequencies from two or more different data periods can be combined to generate the LIDAR data. For instance, the beat frequency determined from DP₁ in FIG. 4C can be combined with the beat frequency determined from DP₂ in FIG. 4C to determine the LIDAR data. As an example, the following equation applies during a data period where electronics increase the frequency of the outgoing LIDAR signal precursor and the resulting active outgoing LIDAR signal such as occurs in data period DP₁ of FIG. 4C: f_{ub}=−f_{d}+□□ where f_{ub} is the frequency provided by the transform component, f_{d} represents the Doppler shift (f_{d}=20f_{c}/c) where f_{c} represents the optical frequency (fₒ), c represents the speed of light, □ is the radial velocity between the reflecting object and the LIDAR system where the direction from the reflecting object toward the chip is assumed to be the positive direction, □ is the time in which the light from the system output signal travels to the object and returns to the LIDAR system (the roundtrip time), and c is the speed of light. The following equation applies during a data period where electronics decrease the frequency of the active outgoing LIDAR signal precursor and the resulting active outgoing LIDAR signal such as occurs in data period DP₂ of FIG. 4C: f_{db}=−f_{d}−□□□ where f_{db} is a frequency provided by the transform component (f_{i,LDP} determined from DP₂ in this case). In these two equations, f_{d} and □ are unknowns. These two equations can be solved for the two unknowns. The radial velocity for the sample region then be calculated from the Doppler shift (□=c*f_{d}/(2f_{c})) and/or the separation distance for that sample region can be calculated from c*□/2. As a result, the electronics use each of the beat frequencies as a variable in one or more equations that yield the LIDAR data. As an example, the distance between the LIDAR system and an object in the sample region (R) can be determiner from Equation 1: R=c(f_{ub}−f_{db})/(2(□_{ub}−□_{db}) where □_{ub} represents the rate of the frequency increase during the data period. Additionally, f_{db} represents the beat frequency during a data period where source controller 63 decreases the frequency of the outgoing LIDAR signal precursor and the resulting active outgoing LIDAR signal such as occurs in data period DP₂ from FIG. 4C through FIG. 4E and □_{db} represents the rate of the frequency decrease during the data period with a decreasing frequency and □_{ub} represents the rate of the frequency decrease during the data period with an increasing frequency. Additionally, the radial velocity between the reflecting object and the LIDAR system (□) can be calculated Equation 2: □=□(□_{db}f_{ub}−□_{ub}f_{db})/(2(□_{ub}−□_{db})). The LIDAR data generator 270 can execute the attributed functions using firmware, hardware or software or a combination thereof.

The data period labeled DP₃ in FIG. 4C is optional. In some situations, there can be more than one object in a sample region. For instance, during the feedback period in DP₁ for cycle₂ and also during the feedback period in DP₂ for cycle₂, more than one frequency pair can be matched. In these circumstances, it may not be clear which frequency peaks from DP₂ corresponds to which frequency peaks from DP₁. As a result, it may be unclear which frequencies need to be used together to generate the LIDAR data for an object in the sample region. As a result, there can be a need to identify corresponding frequencies. The identification of corresponding frequencies can be performed such that the corresponding frequencies are frequencies from the same reflecting object within a sample region. The data period labeled DP₃ can be used to find the corresponding frequencies. LIDAR data can be generated for each pair of corresponding frequencies and is considered and/or processed as the LIDAR data for the different reflecting objects in the sample region.

An example of the identification of corresponding frequencies uses a LIDAR system where the cycles include three data periods (DP₁, DP₂, and DP₃) as shown in FIG. 4C. When there are two objects in a sample region illuminated by the LIDAR outputs signal, the transform component outputs two different frequencies for f_{ub}: fᵤ₁ and fᵤ₂ during DP₁ and another two different frequencies for f_{db}: f_{d1} and f_{d2} during DP₂. In this instance, the possible frequency pairings are: (f_{d1}, fᵤ₁); (f_{d1}, fᵤ₂); (f_{d2}, fᵤ₁); and (f_{d2}, f_{du2}). A value of f_{d} and □ can be calculated for each of the possible frequency pairings. Each pair of values for f_{d} and □ can be substituted into f₃=f_{d}+□₃□₀ to generate a theoretical f₃ for each of the possible frequency pairings. The value of □₃ is different from the value of □ used in DP₁ and DP₂. In FIG. 4C, the value of □₃ is zero. In this case, the transform component also outputs two values for f₃ that are each associated with one of the objects in the sample region. The frequency pair with a theoretical f₃ value closest to each of the actual f₃ values is considered a corresponding pair. LIDAR data can be generated for each of the corresponding pairs as described above and is considered and/or processed as the LIDAR data for a different one of the reflecting objects in the sample region. Each set of corresponding frequencies can be used in the above equations to generate LIDAR data. The generated LIDAR data will be for one of the objects in the sample region. As a result, multiple different LIDAR data values can be generated for a sample region where each of the different LIDAR data values corresponds to a different one of the objects in the sample region.

FIG. 5 includes a portion of the LIDAR chip that includes a waveguide construction that is suitable for use with chips constructed from silicon-on-insulator wafers. A ridge 306 of the light-transmitting medium 304 extends away from slab regions 308 of the light-transmitting medium 304. The light signals are constrained between the top of the ridge and the buried layer 300. As a result, the ridge 306 at least partially defines the waveguide. A suitable light-transmitting medium 304 includes, but is not limited to, silicon, silicon nitride (Si₃N₄) and titanium dioxide (TiO₂).

The dimensions of the ridge waveguide are labeled in FIG. 5. For instance, the ridge has a width labeled w and a height labeled h. The thickness of the slab regions is labeled t. For LIDAR applications, these dimensions can be more important than other applications because of the need to use higher levels of optical power than are used in other applications. The ridge width (labeled w) is greater than 1 □m and less than 4 □m, the ridge height (labeled h) is greater than 1 □m and less than 4 □m, the slab region thickness is greater than 0.5 □m and less than 3 □□m. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 □m and less than 0.5 □m. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction of FIG. 5 is suitable for all or a portion of the waveguides on a LIDAR chip constructed according to FIG. 1A.

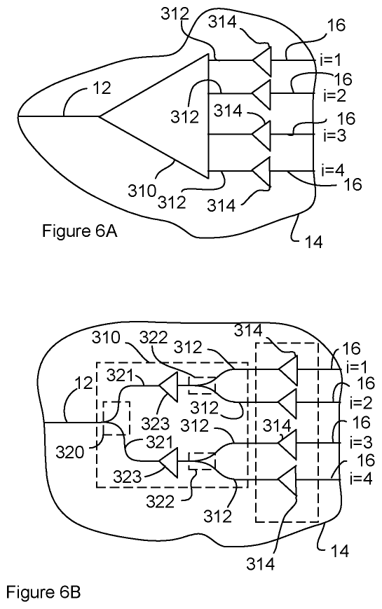

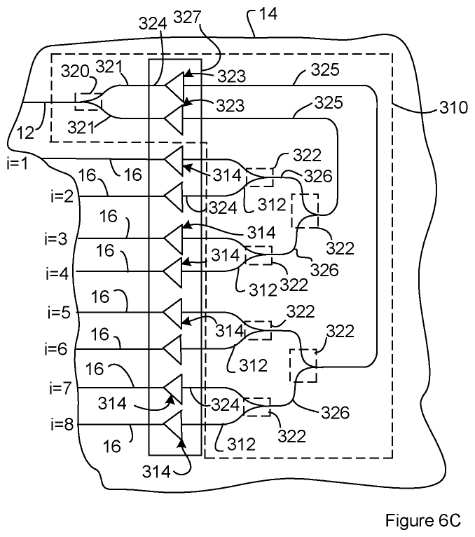

The signal selector 14 can include one or more splitters and one or more amplifiers. FIG. 6A is schematic of an example of a suitable signal selector 14. The signal selector 14 includes a light signal splitter 310 that receives the outgoing LIDAR signal precursor from the utility waveguide 12. The light signal splitter 310 divides the outgoing LIDAR signal precursor into multiple preliminary outgoing LIDAR signals. Each of the preliminary outgoing LIDAR signals is received on a different one of the preliminary alternate waveguides 312. The light signal splitter 310 can be a wavelength independent splitter. Suitable wavelength independent splitters include, but are not limited to, cascaded Y-junctions, cascaded MMI splitters, and star couplers. Each of the preliminary alternate waveguides 312 carries one of the preliminary outgoing LIDAR signals to an amplifier 314. Each of the amplifiers 314 is configured to output an outgoing LIDAR signal that includes light from one of the preliminary outgoing LIDAR signals.

The selector controller 15 can operate each of the amplifiers 314 so as to amplify the power of the preliminary outgoing LIDAR signals passing through the amplifier or to allow the preliminary outgoing LIDAR signal to pass through the amplifier without amplification. In some instances, operating an amplifier below an amplification threshold effectively causes attenuation of the preliminary outgoing LIDAR signal. As an example, Semiconductor Optical Amplifiers (SOAs) amplify a preliminary outgoing LIDAR signal when a forward bias is applied to the Semiconductor Optical Amplifier (SOA). When a reverse-bias is applied to the Semiconductor Optical Amplifiers (SOAs), the gain medium absorbs a preliminary outgoing LIDAR signal and further attenuates the preliminary outgoing LIDAR signal through which it travels. Accordingly, when the selector controller 15 operates one of the amplifiers 314 such that the electrical current through the gain medium falls below the current threshold, the amplifier 314 can attenuate the power of the preliminary outgoing LIDAR signal. As a result, the selector controller 15 can operate each of the amplifiers 314 such that the amplifier outputs an outgoing LIDAR signal that is amplified relative to the preliminary outgoing LIDAR signal received by the amplifier 314, that is unamplified relative to the preliminary outgoing LIDAR signal received by the amplifier 314, that is attenuated relative to the preliminary outgoing LIDAR signal received by the amplifier 314, or that has zero, insubstantial or negligible power.

The light signal splitter 310 can include one or more amplifiers. As an example, FIG. 6B is a schematic of a signal selector 14 having a light signal splitter 310 that includes multiple amplifiers 323. The signal splitter 310 includes cascaded splitters. In FIG. 6B, the cascaded splitters are cascaded Y-junctions. A first one of the splitters 320 receives the outgoing LIDAR signal precursor and divides it into outgoing LIDAR signal portions that are each received on a different intermediate waveguide 321. Each of the intermediate waveguides 321 carries one of the outgoing LIDAR signal portions to a cascade splitter 322. Each of the cascade splitters 322 divides the outgoing LIDAR signal portions into multiple preliminary outgoing LIDAR signals that are each received on a different one of the preliminary alternate waveguides 312. The light signal splitter 310 can be a wavelength independent splitter. Suitable wavelength independent splitters include, but are not limited to, cascaded Y-junctions, cascaded MMI splitters, and star couplers.

An amplifier 323 is positioned along each of the intermediate waveguides 321. The selector controller 15 can operate the amplifiers 323 so as to amplify the outgoing LIDAR signal portions and accordingly any resulting outgoing LIDAR signals.

All or a portion of the amplifiers included in the signal selector 14 can be included in an amplifier chip. For instance, an amplifier chip can include all or a portion of the amplifiers 314 and/or all or a portion of the amplifiers 323. As an example, FIG. 6C is a schematic of a signal selector 14 with a light signal splitter 310 that includes amplifiers 323 on an amplifier chip that also includes amplifiers 314. The signal splitter includes cascaded splitters. In FIG. 6C, the cascaded splitters are cascaded Y-junctions. A first one of the splitters 320 receives the outgoing LIDAR signal precursor and divides it into outgoing LIDAR signal portions that are each received on a different intermediate waveguide 321. Each of the intermediate waveguides 321 carries one of the outgoing LIDAR signal portions to an amplifier 323 on an amplifier chip 327. Each of the amplifiers 323 includes an amplifier waveguide 324 that receives the outgoing LIDAR signal portion and outputs a secondary outgoing LIDAR signal portion. Each of the secondary outgoing LIDAR signal portions are received on a secondary intermediate waveguide 325. Each of the secondary intermediate waveguide 325 carries one of the secondary outgoing LIDAR signal portions to a cascade splitter 322. Each of the cascade splitters 322 divides one of the secondary outgoing LIDAR signal portions into multiple preliminary outgoing LIDAR signals that are each received on a different tertiary intermediate waveguide 326. Each of the tertiary intermediate waveguides 326 carries one of the preliminary outgoing LIDAR signals to a cascade splitter 322 that divides one of the preliminary outgoing LIDAR signals into preliminary outgoing LIDAR signals. The preliminary outgoing LIDAR signals are each received on one of the preliminary alternate waveguides 312. Each of the preliminary alternate waveguides 312 carries one of the preliminary outgoing LIDAR signals to an amplifier 314 on the amplifier chip 327. Each of the amplifiers 314 includes an amplifier waveguide 324 that receives one of the preliminary outgoing LIDAR signals. The amplified or unamplified preliminary outgoing LIDAR signal output by each of the amplifiers 314 serves as one of the outgoing LIDAR signals. Each of the outgoing LIDAR signals is received by one of the alternate waveguides 16. Suitable amplifiers 314 and/or amplifiers 323 include, but are not limited to, Semiconductor Optical Amplifiers (SOAs). Suitable splitters 320 and/or cascade splitters 322 include wavelength independent splitters such as Y-junctions, MMI splitters, star couplers, cascaded Y-junctions, and cascaded MMI splitters.

The selector controller 15 can operate the amplifiers 314 so as to select which amplifiers 314 serve as an active amplifier and which amplifiers 314 serve as an inactive amplifier. For instance, the selector controller 15 can operate one or more amplifiers 314 so as to substantially amplify the power of the light included in the system output signal that is output from each of the one or more amplifiers. Additionally, the selector controller 15 can concurrently operate one or more amplifiers 314 so to not amplify, or not substantially amplify, the power of the light included in the system output signal that is output from each of the one or more amplifiers. Any amplifiers that substantially amplify the power of the light included in the system output signal output from the amplifier serve as the active amplifiers. The amplifiers that do not amplify, or do not substantially amplify, the power of the light included in the system output signal serve as the inactive amplifiers. For instance, one example of a suitable amplifier includes Semiconductor Optical Amplifiers (SOAs). Semiconductor Optical Amplifiers (SOAs) include a semiconductor gain medium to which a forward electrical bias so as to amplify the power of the light in the system output signal. These amplifiers can be operated as active amplifiers by applying an electrical bias above a threshold voltage in the direction needed to provide amplification. Semiconductor Optical Amplifiers (SOAs) can also be operated as inactive amplifiers by not applying an electrical bias to the amplifier, by applying the electrical bias below the threshold voltage in the direction needed to provide amplification, by applying a reverse electrical bias to the amplifier so as to attenuate the power of the light in the system output signal, or by applying the electrical bias in the direction opposite from the direction needed to provide amplification. Application of the electrical bias in the direction opposite from the direction needed to provide amplification can provide attenuation of the system output signal. For instance, a forward bias above a voltage threshold is often applied to Semiconductor Optical Amplifiers (SOAs) in order to achieve amplification while application of a reverse bias can provide attenuation. Accordingly, the inactive amplifiers can output a system output signal with a power level that is the same as, substantially the same as, or below the power of the preliminary outgoing LIDAR signal received by the amplifier.

The operation of the amplifiers 314 selects which of the alternate waveguides serves as the active alternate waveguide that receives the active outgoing LIDAR signal. For instance, the outgoing LIDAR signal output from the active amplifier can serve as the active outgoing LIDAR signal and the alternate waveguide the receives the active outgoing LIDAR signal can serve as the active alternate waveguide. In some instances, all or a portion of the amplifiers 314 can have a length such that when the selector controller 15 operates an amplifier as an inactive amplifier, the outgoing LIDAR signal output from the amplifier has zero, or substantially zero, power. As a result, when the selector controller 15 operates all or a portion of the amplifiers as inactive amplifiers, each of the inactive amplifiers effectively does not output a signal. Accordingly, a portion of the inactive alternate waveguides 16 may not receive an inactive outgoing LIDAR signal. However, all or a portion of the amplifiers operated as inactive amplifiers can output a signal with a power level that is negligible or insubstantial relative to the power of the active outgoing LIDAR signal. In the event that one or more of the inactive amplifiers outputs a signal received by an inactive alternate waveguide with a power level that is negligible or insubstantial relative to the power of the active outgoing LIDAR signal, the signal output from the inactive amplifier can serve as an inactive outgoing LIDAR signal. Accordingly, inactive amplifiers can output an inactive outgoing LIDAR signal or no outgoing LIDAR signal at all. While the electronics use light from any active outgoing LIDAR signals to generate LIDAR data, the electronics do not use light from inactive outgoing LIDAR signal to generate LIDAR data. For instance, the electronics can operate the signal processor 28 that is associated with the active outgoing LIDAR signal so as to generate LIDAR data while not generating LIDAR data at the signal processor(s) 28 associated with inactive outgoing LIDAR signals. For instance, the electronics can operate the signal processor 28 that is receiving the comparative signal from the active alternate waveguide so as to generate LIDAR data while not generating LIDAR data at the signal processor 28 that would receive a comparative signal from an inactive alternate waveguide. The act of not generating LIDAR data at a signal processor 28 may be a result of a beating signal not having enough power, a result of the associated inactive outgoing signal not having sufficient power and/or a result of functionality in the electronics.

An alternative to having a data processor 237 for each light signal processor 28 operated by the electronics 62 in a core is to add together the first data signals carried on the first data lines of a core and add together the second data signals carried on the second data lines of the core. The added first data signals and the added second data signals could then be received at the beat frequency identifier 238 and the LIDAR data generator 270 for the generation of the LIDAR data. For instance, the added first data signal can serve as the first data signal input to the LIDAR data generator 270 and the added second data signal can serve as the second data signal input to the LIDAR data generator 270. In this configuration, any beating signals that result from a comparative signal carrying light output from an inactive alternate waveguide does not provide a substantial contribution to the added first data signals or the added second data signals. As a result, the comparative signal carrying light output from the active alternate waveguide is the source of the beat frequency identified by the beat frequency identifier 238 while the comparative signals carrying light output from the inactive alternate waveguide do not contribute to the beat frequency identified by the beat frequency identifier 238. Accordingly, the LIDAR system calculates the LIDAR data from the light output from the active outgoing LIDAR signal but not from the light output from the inactive amplifiers.

In some instances, the selector controller 15 operate the amplifiers 314 such that a ratio of the power of the active outgoing LIDAR signal received by the active alternate waveguide: the power of any inactive outgoing LIDAR signal received by an inactive alternate waveguides is greater than 10,000:1, 1000:1 or 100:1 for each of the inactive alternate waveguides and can be infinitely high when an inactive amplifier 314 outputs an outgoing LIDAR signal with a zero power level or does not output an outgoing LIDAR signal. Additionally, or alternately, the selector controller 15 can operate all or a portion of the inactive amplifiers 314 such that a power level of the preliminary outgoing LIDAR signal received by the inactive amplifier is more than 10, 100, or 1000 times a power level of the inactive outgoing LIDAR signal output from the inactive amplifier.

As shown in FIG. 1A, variable optical attenuators 328 can optionally be positioned along the alternate waveguides. Each of the variable optical attenuators 328 can be configured to attenuate the power of an outgoing LIDAR signal carried in one of the alternate waveguides. The electronics can operate the variable optical attenuators 328. For instance, the selector controller 15 can operate each of the variable optical attenuators so as to attenuate the power of the outgoing LIDAR signal carried in one of the alternate waveguides. Each variable optical attenuator that receives an inactive outgoing LIDAR signal can serve as an inactive optical attenuator and each variable optical attenuator that receives an active outgoing LIDAR signal can serve as an active optical attenuator. The selector controller 15 can operate the inactive variable optical attenuators so as to attenuate the power of any inactive outgoing LIDAR signal without attenuating while operating any active variable optical attenuators so as to not attenuate, or not substantially attenuate, any active outgoing LIDAR signals. In some instances, operating an active variable optical attenuator so as to not attenuate, or not substantially attenuate, an active outgoing LIDAR signals includes refraining from an activity that causes the variable optical attenuator to provide attenuating functionality. For instance, in some instances, operating an active variable optical attenuator so as to not substantially attenuate an active outgoing LIDAR signal includes refraining from applying an electrical bias to the active variable optical attenuator. In response to changes in the alternate waveguide that serves as the active alternate waveguide, the selector controller 15 can change the selectin of variable optical attenuators that are inactive variable optical attenuators and active variable optical attenuators.

In some instances, the operation of one or more of the amplifiers may not reduce the power of the inactive outgoing LIDAR signal output from the amplifier to the desired power level. The selector controller 15 can operate the variable optical attenuators so as to reduce the power of each inactive outgoing LIDAR signal to the desired level. In some instances, the selector controller 15 operates all or a portion of the inactive amplifiers 314 and the associated variable optical attenuators such that a power level of the preliminary outgoing LIDAR signal received by each inactive amplifier is more than 100, 1000, or 10,000 times a power level of the inactive outgoing LIDAR signal output from the variable optical attenuator that receives the inactive outgoing LIDAR signal output from the amplifier. Additionally, or alternately, the selector controller 15 can operate the amplifiers 314 and variable optical attenuators such that a ratio of the power of the active outgoing LIDAR signal output from each active variable attenuator: the power of any inactive outgoing LIDAR signal output from each inactive variable attenuator is greater than 10,000:1, 1000:1 or 100:1.

As noted above, the selector controller 15 can operate the variable optical attenuators such that the active outgoing LIDAR signal carried in one or more of the alternate waveguides is not attenuated or is not substantially attenuated. Variable optical attenuators such as PIN diode-based VOAs provide attenuation by applying a bias to the attenuator above a voltage threshold. By applying a bias below the voltage threshold to the attenuator positioned along the alternate waveguide carrying the active outgoing LIDAR signal, the active outgoing LIDAR signal is not attenuated or is not substantially attenuated. Suitable variable optical attenuators include, but are not limited to, PIN diode-based VOAs, liquid crystal variable attenuators, and Lithium Niobate devices.

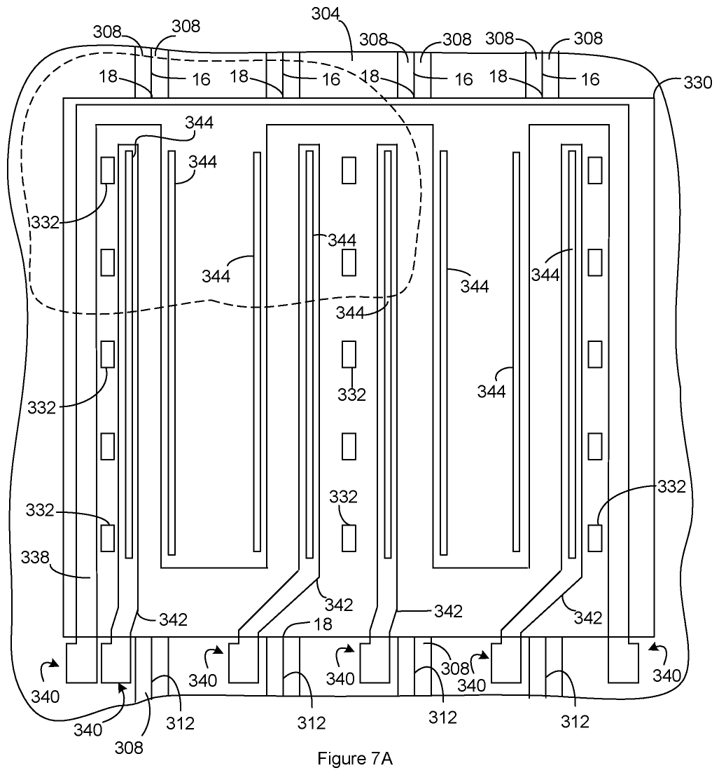

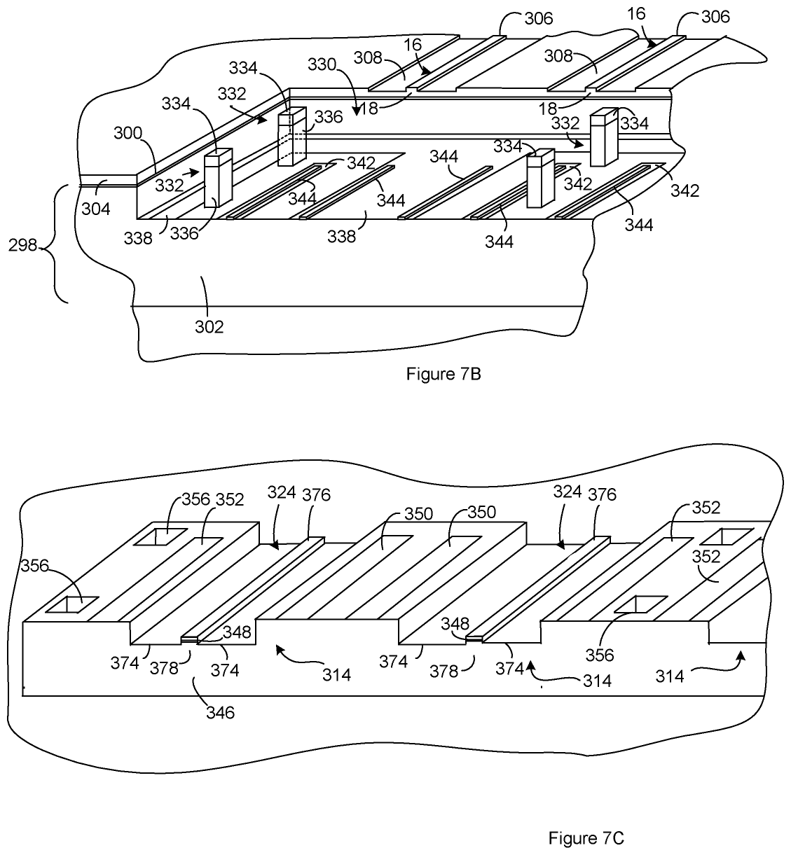

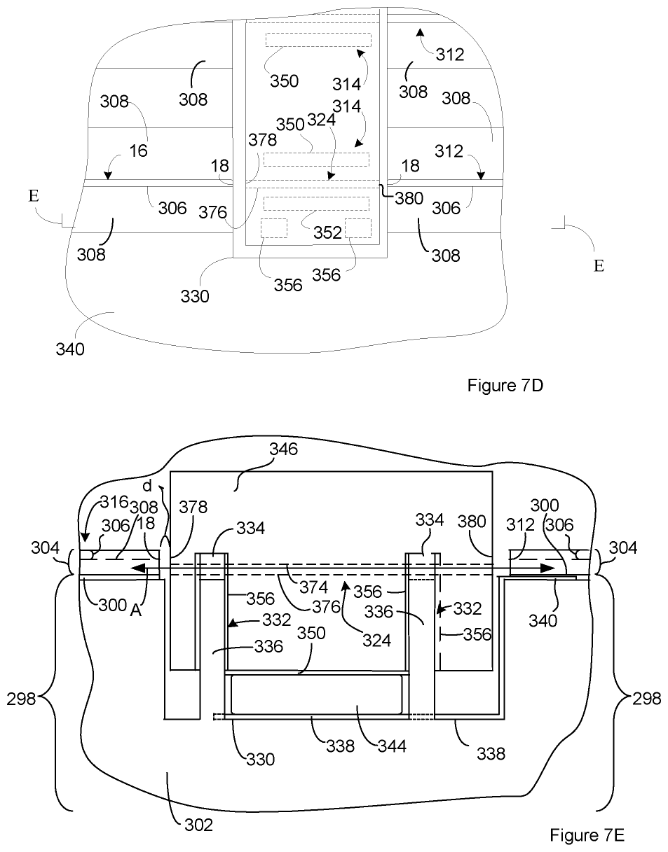

FIG. 7A through FIG. 7E illustrates an example of an interface between an amplifier chip and a LIDAR chip. FIG. 7A is a perspective view of a portion of a LIDAR chip that includes an interface for optically coupling the LIDAR chip with an amplifier chip. FIG. 7B is a perspective view of the portion of a LIDAR chip shown by the dashed lines in FIG. 7A labeled B. The LIDAR chip includes a stop recess 330 sized to receive the amplifier chip. The stop recess 330 extends through the light-transmitting medium 304 and into the base 298. In the illustrated version, the stop recess 330 extends through the light-transmitting medium 304, the buried layer 300, and into the substrate 302.

The facets 18 of the preliminary alternate waveguides 312 and the facets 18 of the alternate waveguides 16 are included in the lateral sides of the stop recess 330. Although not shown, the facets 18 of the preliminary alternate waveguides 312 and the facets 18 of the alternate waveguides 16 can include an anti-reflective coating. A suitable anti-reflective coating includes, but is not limited to, single-layer coatings such as silicon nitride or aluminum oxide, or multi-layer coatings, which may contain silicon nitride, aluminum oxide, and/or silica.

One or more stops 332 extend upward from a bottom of the stop recess 330. For instance, FIG. 7B illustrates four stops 332 extending upward from the bottom of the stop recess 330. The stops 332 include a cladding 334 positioned on a base portion 336. The substrate 302 can serve as the base portion 336 of the stops 332 and the stop 332 can exclude the buried layer 300. The portion of the substrate 302 included in the stops 332 can extend from the bottom of the stop recess 330 up to the level of the buried layer 300. For instance, the stops 332 can be formed by etching through the buried layer 300 and using the underlying substrate 302 as an etch-stop. As a result, the location of the top of the base portion 336 relative to the optical mode of a light signal in an alternate waveguide 16 and/or a preliminary alternate waveguide 312 is well known because the buried layer 300 defines the bottom of the second waveguide and the top of the base portion 336 is located immediately below the buried layer 300. The cladding 334 can be formed on base portion 336 of the stops 332 so as to provide the stops 332 with a height that will provide the desired vertical alignment between each amplifier waveguide 324 on an amplifier chip and one of the alternate waveguides 16 and/or one of the preliminary alternate waveguides 312.

A first electrical conductor 338 extends from a top side of the LIDAR chip, over a lateral side of the stop recess 330 and across a bottom of the stop recess 330. The first electrical conductor 338 can include a contact pad 340 that can be used to provide electrical communication between the electronics and the first electrical conductor 338. Second electrical conductors 342 each extend from a top side of the LIDAR chip, over a lateral side of the stop recess 330 and across a bottom of the stop recess 330. Each of the second electrical conductors 342 can include a contact pad 340 that can be used to provide electrical communication between the electronics and the second electrical conductor 342. Solder 344 is positioned on the first electrical conductor 338 and the second electrical conductors 342.

FIG. 7C is a perspective view of one embodiment of an amplifier chip. The illustrated amplifier chip is within the class of devices known as planar optical devices. The amplifier chip includes an amplifier waveguide 324 defined in a gain medium 346. Suitable gain media include, but are not limited to, InP, InGaAsP, and GaAs.

Trenches 374 extending into the gain medium 346 define a ridge 376 in the gain medium 346. The ridge 376 defines the amplifier waveguide 324. In some instances, the gain medium 346 includes one or more layers 348 in the ridge and/or extending across the ridge 376. The one or more layers 348 can be positioned between different regions of the gain medium 346. The region of the gain medium 346 above the one or more layers 348 can be the same as or different from the region of the gain medium 346 below the one or more layers 348. The layers can be selected to constrain light signals guided through the amplifier waveguide 324 to a particular location relative to the ridge 376. Each of the layers 348 can have a different composition of a material that includes or consists of two or more components selected from a group consisting of In, P, Ga, and As. In one example, the gain medium 346 is InP and the one or more layers 348 each includes Ga and As in different ratios.

The amplifier waveguide 324 provides an optical pathway between a first facet 378 and a second facet 380. Although not shown, the first facet 378 and/or the second facet 380 can optionally include an anti-reflective coating. A suitable anti-reflective coating includes, but is not limited to, single-layer coatings such as silicon nitride or aluminum oxide, or multi-layer coatings that may contain silicon nitride, aluminum oxide, and/or silica.

The amplifier chip includes first amplifier electrical conductors 350 and second amplifier electrical conductors 352. The first amplifier electrical conductors 350 are arranged on the amplifier chip such that the amplifier chip can be inverted and placed in the stop recess 330 with each of the first amplifier electrical conductors 350 aligned with a portion of the first electrical conductor 338 such that solder 344 is positioned between the first amplifier electrical conductors 350 and the first electrical conductor 338 with the solder contacting the first amplifier electrical conductors 350 and the first electrical conductor 338. The second amplifier electrical conductors 352 are arranged on the amplifier chip such that the amplifier chip can be inverted and placed in the stop recess 330 with each of the second amplifier electrical conductors 352 aligned with one of the second electrical conductors 340 such that solder 344 is positioned between the second amplifier electrical conductors 352 and the second electrical conductor 340 and the solder 344 contacts the second amplifier electrical conductors 352 and the second electrical conductor 340.

The amplifier chip also includes one or more alignment recesses 356. Each of the alignment recesses 356 is sized to receive one of the stops 332.

FIG. 7D and FIG. 7E illustrate a LIDAR system that includes the LIDAR chip of FIG. 7A and FIG. 7B interfaced with the amplifier chip of FIG. 7C. The LIDAR chip is inverted and positioned in the stop recess 330. FIG. 7D is a topview of the LIDAR system. FIG. 7E is a sideview of a cross section of the system taken through the alternate waveguide 16 on the LIDAR chip and the amplifier waveguide 324 on the amplifier chip. For instance, the cross section of FIG. 7E can be taken along a line extending through the brackets labeled E in FIG. 7D. FIG. 7D and FIG. 7E each includes dashed lines that illustrate features that are located behind other features in the system. For instance, FIG. 7D includes dashed lines the show the locations of the ridge 376 of the amplifier waveguide 324, the first amplifier electrical conductors 350, the second amplifier electrical conductors 352 and the alignment recesses 356 under the gain medium 346. Additionally, FIG. 7E includes dashed lines that illustrate the locations of the amplifier waveguide 324 behind the stops 332. FIG. 7E also includes dashed lines that illustrate the location where the ridge 86 of the alternate waveguide 16 interfaces with the slab regions 308 that define the alternate waveguide 16 and dashed lines that illustrate the location where the ridge 376 of the amplifier waveguide 324 interfaces with slab regions 374 of the amplifier chip.

The amplifier chip is positioned in the stop recess 330 on the LIDAR chip. The amplifier chip is positioned such that the ridge 376 of the amplifier waveguide 324 is located between the bottom of the amplifier chip and the base 298 of the LIDAR chip. Accordingly, the amplifier chip is inverted in the stop recess 330. Solder 344 or other electrically conducting adhesive contacts each of the first amplifier electrical conductors 350 and the first electrical conductor 338. Although not shown in FIG. 3E, the solder 344 or other electrically conducting adhesive contacts are arranged such that the solder 344 or other electrically conducting adhesive contacts each of the second amplifier electrical conductors 352 and one of the second electrical conductor 340. The solder 344 or other adhesive 358 can immobilize the amplifier chip relative to the LIDAR chip.

The facet 18 of the alternate waveguide 16 is aligned with the first facet 378 of the amplifier waveguide 324 such that the alternate waveguide 16 and the amplifier waveguide 324 can exchange light signals. Additionally, the facet 18 of the preliminary alternate waveguide 312 is aligned with the second facet 380 of the amplifier waveguide 324 such that the preliminary alternate waveguide 312 and the amplifier waveguide 324 can exchange light signals. As shown by the line labeled A, the system provides a horizontal optical path in that the direction that light signals travel from the LIDAR chip, through the amplifier chip and back into the LIDAR chip is parallel or is substantially parallel relative to an upper and/or lower surface of the base 298. A top of the first facet 378 of the amplifier waveguide 324 is at a level that is below the top of the facet 18 of the alternate waveguide and below the top of the facet 18 of the preliminary alternate waveguide 312.

The one or more stops 332 on the LIDAR chip are each received within one of the alignment recesses 356 on the amplifier chip. The top of each stop 332 contacts the bottom of the alignment recess 356. As a result, the interaction between stops 332 and the bottom of the alignment recesses 356 prevents additional movement of the amplifier chip toward the LIDAR chip. In some instances, the amplifier chip rests on top of the stops 332.

As is evident from FIG. 7E, the first facet 378 of the amplifier waveguide 324 is vertically aligned with the facet 18 of the alternate waveguide 16 on the LIDAR chip and the second facet 380 of the amplifier waveguide 324 is vertically aligned with the facet 18 of the preliminary alternate waveguide 312 on the LIDAR chip. As is evident from FIG. 7D, the first facet 378 of the amplifier waveguide 324 is horizontally aligned with the facet 18 of the alternate waveguide 16 on the LIDAR chip. The horizontal alignment can be achieved by alignment of marks and/or features on the amplifier chip and the LIDAR chip.

The vertical alignment can be achieved by controlling the height of the stops 332 on the LIDAR chip. For instance, the cladding 334 on the base portion 336 of the stops 332 can be grown to the height that places the first facet 378 of the amplifier waveguide 324 at a particular height relative to the facet 18 of the alternate waveguide 16 on the LIDAR chip. The desired cladding 334 thickness can be accurately achieved by using deposition techniques such as evaporation, plasma enhanced chemical vapor deposition (PECVD), and/or sputtering to deposit the one or more cladding layers. As a result, one or more cladding layers can be deposited on the base portion 336 of the stops 332 so as to form the stops 332 to a height that provides the desired vertical alignment. Suitable materials for layers of the cladding 334 include, but are not limited to, silica, silicon nitride, and polymers.

In FIG. 7E, the first facet 378 is spaced apart from the facet 18 by a distance labeled d. The second facet 380 is also spaced apart from the facet 18 by a distance labeled d. The distance “d” can be less than 5 μm, 3 μm, or 1 μm and/or greater than 0.0 □m. In FIG. 7E, the atmosphere in which the LIDAR chip is positioned is located in the gap between the first facet 378 and a facet 18 and also between the second facet 380 and a facet 18; however, other gap materials can be positioned in one or more of these gaps. For instance, a solid gap material can be positioned in the gap. Examples of suitable gap materials include, but are not limited to, epoxies and polymers.

FIG. 7E shows the solder 344 in contact with the first amplifier electrical conductor 350 and the first electrical conductor 338. As a result, the first amplifier electrical conductor 350, the solder 344, and the first electrical conductor 338 can provide electrical communication between a contact pad 340 on the first electrical conductor 338 and the amplifier. Although not illustrated, the second amplifier electrical conductor 352, the solder 344, and the second electrical conductor 342 can provide electrical communication between the contact pad 340 on the second electrical conductor 342 and an amplifier on the amplifier chip. Accordingly, the electronics can independently operate each of the amplifiers on the amplifier chip by applying a bias between contact pad 340 on the first electrical conductor 338 and the contact pad 340 on the second electrical conductor 342 that is associated with the amplifier. The bias can be applied so as to drive an electrical current through the gain medium in the amplifier. During concurrent operation of multiple different amplifiers, the first electrical conductor 338 can act as a common conductor.

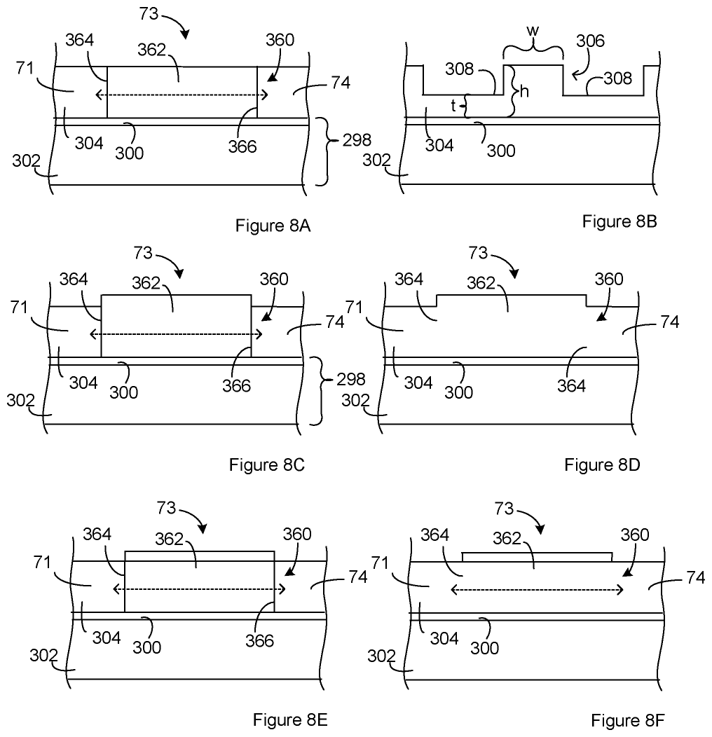

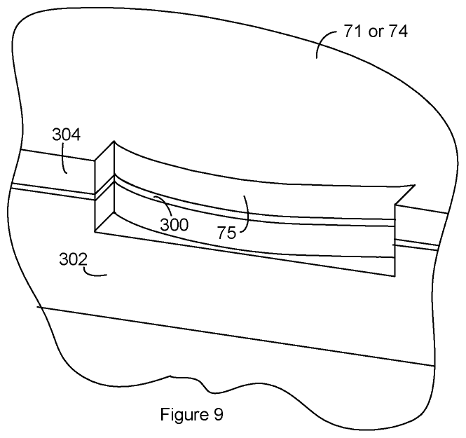

FIG. 8A illustrates a suitable construction for a lens integrated into a LIDAR chip such as the lens 73 illustrated in FIG. 1A through FIG. 2. For instance, FIG. 8A can represent a cross-section of the lens 73 shown in FIG. 1A taken along the line labeled L in FIG. 1A. FIG. 8B is a cross-section of an example waveguide and is provided for the purposes of comparison to the lens 73 of FIG. 8A. The lens is illustrated on a silicon-on-insulator wafer but can be constructed on other platforms. The LIDAR chip includes a recess 360 extending into the light-transmitting medium 304. Although the recess 360 is shown extending through the light-transmitting medium 304, the recess 360 can extend part-way through the light-transmitting medium 304. A second light-transmitting medium 362 is positioned in the recess such that lateral sides of the second light-transmitting medium 362 contact lateral sides of the light-transmitting medium 304. A top side of the second light-transmitting medium 362 can be flush or substantially flush with a top side of the light-transmitting medium 304. The dashed line in FIG. 8A can represent an outgoing LIDAR signal and/or an incoming LIDAR signal traveling through the lens 73. The outgoing LIDAR signal and/or an incoming LIDAR signal pass through the interfaces between the second light-transmitting medium 362 and the light-transmitting medium 304.

The lens 73 can have an index of refraction that is more than the index of refraction of the light-transmitting medium 304. For instance, the second light-transmitting medium 362 can have an index of refraction that is more than the index of refraction of the light-transmitting medium 304. Suitable second light-transmitting media 362 include, but are not limited to, silicon, and titanium dioxide (TiO₂). For instance, when the light-transmitting medium 304 is silicon nitride or titanium dioxide, the second light-transmitting media 362 can be silicon. Alternately, when the light-transmitting medium 304 is silicon nitride, the second light-transmitting medium 362 can be titanium dioxide (TiO₂). The second light-transmitting medium 362 can be a solid.

The index of refraction of the lens 73 can be increased by increasing the thickness of the second light-transmitting medium 362. For instance, FIG. 8C represents the cross section of FIG. 8A modified so as to provide the second light-transmitting medium 362 with a thickness that exceeds the thickness of the light-transmitting medium 304. Accordingly, the thickness of the lens 73 exceeds the thickness of the free space region 71 and/or the free space region 74. Since the increased thickness of the lens 73 increases the index of refraction of the lens 73, when the thickness of the lens 73 exceeds the thickness of the free space region 71 and/or the free space region 74, the second light-transmitting medium 362 can have an index of refraction that is greater than or equal to the index of refraction of the light-transmitting medium 304. Since the second light-transmitting medium 362 can be equal to the index of refraction of the light-transmitting medium 304, the second light-transmitting medium 362 and the light-transmitting medium 304 can be the same material. As an example, FIG. 8D represents the cross section of FIG. 8C modified such that the second light-transmitting medium 362 and the light-transmitting medium 304 are the same material. A portion of the light-transmitting medium 304 that defines the lens 73 is proud of the portion of the light-transmitting medium 304 that defines the free space region 71 and/or the free space region 74. The proud portion of the light-transmitting medium 304 provides the lens with the desired signal-shaping functionality. As a result, the light-transmitting medium 304 can have one or more proud portions configured to increase collimation of the outgoing LIDAR signal in a first plane that is parallel to the plane of the LIDAR chip without collimating, or substantially collimating, the outgoing LIDAR signal in a second plane that is perpendicular to the plane of the LIDAR chip.

The index of refraction of the lens 73 can be increased by adding an index layer 364 that defines the lens 73 on the light-transmitting medium 304 or on the second light-transmitting medium 362. As an example, FIG. 8E represents the cross section of FIG. 8A modified to include an index layer 364 on the second light-transmitting medium 362. The index layer can include or consist of a third light-transmitting medium. The presence of the index layer 364 can increase the effective index of refraction of the lens 73 above the index of refraction of the free space region 71 and/or the free space region 74. The index of refraction of the third light-transmitting medium can be greater than or equal to the index of refraction of the second light-transmitting medium 362 and/or the light-transmitting medium 304, however, a third light-transmitting medium with an index of refraction less than the index of refraction of the second light-transmitting medium 362 and/or the light-transmitting medium 304 can increase the effective index of refraction of the lens 73 above the index of refraction of the free space region 71 and/or the free space region 74 due to the increase in effective thickness of the lens 73 provided by the index layer 364. Suitable materials for the third light-transmitting medium, include, but are not limited to, silicon nitride (Si₃N₄), titanium dioxide (TiO₂), polysilicon and silicon.

Since the index layer 364 can increase the index of refraction of the lens 73, the second light-transmitting medium 362 can have an index of refraction that is greater than or equal to the index of refraction of the light-transmitting medium 304. Since the second light-transmitting medium 362 can be equal to the index of refraction of the light-transmitting medium 304, the second light-transmitting medium 362 and the light-transmitting medium 304 can be the same material. As an example, FIG. 8F represents the cross section of FIG. 8E modified such that the second light-transmitting medium 362 and the light-transmitting medium 304 are the same material. The shape of the index layer 364 provides the lens with the desired signal-shaping functionality. As a result, the lens 73 can have one or more index layers 364 selected to increase collimation of the outgoing LIDAR signal in a first plane that is parallel to the plane of the LIDAR chip without collimating, or substantially collimating, the outgoing LIDAR signal in a second plane that is perpendicular to the plane of the LIDAR chip.

FIG. 8A, FIG. 8C, and FIG. 8E illustrate the lens 73 constructed with an interface 366 between the second light-transmitting medium 362 and the light-transmitting medium 304. When there is an interface 366 between the second light-transmitting medium 362 and the light-transmitting medium 304, the interface 366 between the second light-transmitting medium 362 and the light-transmitting medium 304 are illustrated as vertical or substantially vertical relative to the plane of the LIDAR chip. As a result, the interfaces between the second light-transmitting medium 362 and the light-transmitting medium 304 can be curved in a first plane that is parallel to the plane of the LIDAR chip without being curved, or without being substantially curved, in a second plane perpendicular to the plane of the LIDAR chip. When there is an interface 366 between the second light-transmitting medium 362 and the light-transmitting medium 304, the shape of the recess 360 and/or the interface 366 provides the lens with the desired signal-shaping functionality. As a result, the lens 73 can have one or more interfaces 366 selected to increase collimation of the outgoing LIDAR signal in the first plane without collimating, or substantially collimating, the outgoing LIDAR signal in the second plane.

Although the interfaces 366 between the second light-transmitting medium 362 and the light-transmitting medium 304 are illustrated as vertical or substantially vertical relative to the plane of the LIDAR chip, the interfaces can have other configurations. Although FIG. 8 shows the lens positioned between the free space region 71 and the second free space region 74, the free space region 71 and the second free space region 74 can be considered part of a single continuous free space region that includes the lens 73.

Suitable methods for fabricating the recess 360 include, but are not limited to, masking and etching the LIDAR chip. Suitable methods for placing the second light-transmitting media 362 in the recess 360 include, but are not limited to, deposition, and epitaxial growth.

FIG. 9 is a perspective view of an example of a suitable construction of the facet 75. For instance, FIG. 9 can represent a perspective view of the facet 75 shown in FIG. 1A through FIG. 2. The facet 75 is illustrated on a silicon-on-insulator wafer but can be constructed on other platforms. The lateral side of the LIDAR chip includes a curved portion. For instance, a portion of the lateral side of the light-transmitting medium 304 is curved. The curved portion of the lateral side of the light-transmitting medium 304 can serve as the facet 75 of the free space region 71 or as the facet 75 of the second free space region 74.

The curved portion of the lateral side of the LIDAR chip is positioned above the substrate 302 but can be spaced back from the lateral side of the substrate 302 as shown in FIG. 9. The curved portion of the light-transmitting medium 304 is positioned over the substrate 302 and spaced back from the lateral side of the substrate 302. Accordingly, a portion of the substrate 302 can extend out from under the curved portion of the lateral side of the LIDAR chip. The curved portion of the lateral side of the light-transmitting medium 304 can serve as the facet 75 of the free space region 71 or as the facet 75 of the second free space region 74.

FIG. 9 illustrates the curved portion of the lateral side of the LIDAR chip extending into the base of the LIDAR chip. As a result, the base of the LIDAR chip includes a lateral side with a curved portion. For instance, the curved portion of the lateral side of the LIDAR chip continues from the light-transmitting medium 304 through the buried layer 300 and into the substrate 302. As a result, the buried layer 300 and the substrate 302 each have a lateral side that includes a curved portion. The curved portion of the lateral side of the LIDAR chip can continue from the light-transmitting medium 304 through the substrate 302. As a result, the base of the LIDAR chip and/or the substrate 302 need not extend out from under the curved portion of the lateral side of the LIDAR chip. The extension of the curved portion of the lateral side of the LIDAR chip into the base of the LIDAR chip can reduce or eliminate interference between light signals that enter and/or exit the facet 75 and any portion of the base that extends out from under the facet 75. The curved portion of the lateral side of the LIDAR chip extending down through the base of the LIDAR chip is optional. Accordingly, in some instances, the curved portion of the lateral side of the LIDAR chip does not extend into the base of the LIDAR chip and/or terminates at the buried layer 300.

The curved portion of the LIDAR chip and the curved portion of the light-transmitting medium 304 are illustrated as vertical or substantially vertical relative to the plane of the LIDAR chip. As a result, the facet 75 can be curved in a first plane that is parallel to the plane of the LIDAR chip without being curved, or without being substantially curved, in a second plane perpendicular to the plane of the LIDAR chip. As a result, the facet 75 can increase collimation of the outgoing LIDAR signal in the first plane without collimating, or substantially collimating, the outgoing LIDAR signal in the second plane.

Although the curved portion of the LIDAR chip and the curved portion of the light-transmitting medium 304 are illustrated as vertical or substantially vertical relative to the plane of the LIDAR chip, the interfaces can have other configurations.

Suitable methods for fabricating the curved portion of the LIDAR chip and the curved portion of the light-transmitting medium 304 are include, but are not limited to, masking and etching the LIDAR chip. Although not illustrated, the facet 75 can include one or more layers over the surface of the light-transmitting medium 304. For instance, the facet 75 can include an anti-reflective coating. A suitable anti-reflective coating includes, but is not limited to, single-layer coatings such as silicon nitride or aluminum oxide, or multi-layer coatings, which may contain silicon nitride, aluminum oxide, and/or silica.

An example of a variable optical attenuators suitable for use with ridge waveguides on a silicon-on-insulator platform can be found in U.S. patent application Ser. No. 17/396,616, filed on Aug. 6, 2021, entitled “Carrier Injector Having Increased Compatibility,” and incorporated herein in its entirety.

As is evident from FIG. 1A, the LIDAR system can optionally include one or more light signal amplifiers 446 in addition to the amplifiers 314 and any amplifiers 323. For instance, an amplifier 446 can optionally be positioned along a utility waveguide 12 as illustrated in the LIDAR system of FIG. 1A. The electronics can operate the amplifier 446 so as to amplify the power of the outgoing LIDAR signal precursor and accordingly of the resulting system output signal. Suitable amplifiers 446 for use on the LIDAR chip, include, but are not limited to, Semiconductor Optical Amplifiers (SOAs) and SOA arrays.

Light sensors that are interfaced with waveguides on a LIDAR chip can be a component that is separate from the chip and then attached to the chip. For instance, the light sensor can be a photodiode, or an avalanche photodiode. Examples of suitable light sensors include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first light sensor and the second light sensor.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10, 2012; U.S. Pat. No. 8,242,432, issued Aug. 14, 2012; and U.S. Pat. No. 6,108,472, issued on Aug. 22, 2000 each of which is incorporated herein in its entirety. The use of light sensors that are integrated with the chip are suitable for all or a portion of the light sensors selected from the group consisting of the first light sensor and the second light sensor.

Suitable electronics 32 can include, but are not limited to, a controller that includes or consists of analog electrical circuits, digital electrical circuits, processors, microprocessors, digital signal processors (DSPs), Field Programmable Gate Arrays (FPGAs), computers, microcomputers, or combinations suitable for performing the operation, monitoring and control functions described above. In some instances, the controller has access to a memory that includes instructions to be executed by the controller during performance of the operation, control and monitoring functions. In some instances, the functions of the LIDAR data generator and the peak finder can be executed by Field Programmable Gate Arrays (FPGAs), digital signal processors (DSPs), Application Specific Integrated Circuits, firmware, software, hardware, and combinations thereof. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

An example of a suitable selector controller 15 executes the attributed functions using firmware, hardware, or software or a combination thereof. An example of a suitable light source controller 63 executes the attributed functions using firmware, hardware, or software or a combination thereof. An example of a suitable data processor 237 executes the attributed functions using firmware, hardware, or software or a combination thereof. An example of a suitable assembly electronics 280 and electronics 62 executes the attributed functions using firmware, hardware, or software or a combination thereof.

Components on the LIDAR chip can be fully or partially integrated with the LIDAR chip. For instance, the integrated optical components can include or consist of a portion of the wafer from which the LIDAR chip is fabricated. A wafer that can serve as a platform for a LIDAR chip can include multiple layers of material. At least a portion of the different layers can be different materials. As an example, in a silicon-on-insulator wafer that includes the buried layer 300 between the substrate 302 and the light-transmitting medium 304 as shown in FIG. 5, the integrated on-chip components can be formed by using etching and masking techniques to define the features of the component in the light-transmitting medium 304. For instance, the slab regions 308 that define the waveguides and the stop recess can be formed in the desired regions of the wafer using different etches of the wafer. As a result, the LIDAR chip includes a portion of the wafer and the integrated on-chip components can each include or consist of a portion of the wafer. Further, the integrated on-chip components can be configured such that light signals traveling through the component travel through one or more of the layers that were originally included in the wafer. For instance, the waveguide of FIG. 5 guides light signal through the light-transmitting medium 304 from the wafer. The integrated components can optionally include materials in addition to the materials that were present on the wafer. For instance, the integrated components can include reflective materials and/or a cladding.

Although the gain medium is disclosed as having both a laser waveguide and an amplifier waveguide 324, the amplifier waveguide 324 is optional. As a result, the utility waveguide can be continuous with the auxiliary waveguide and/or can serve the auxiliary waveguide.

Numeric labels such as first, second, third, etc. are used to distinguish different features and components and do not indicate sequence or existence of lower numbered features. For instance, a second component can exist without the presence of a first component and/or a third step can be performed before a first step. The light signals disclosed above each include, consist of, or consist essentially of light from the prior light signal(s) from which the light signal is derived. For instance, an incoming LIDAR signal includes, consists of, or consists essentially of light from the LIDAR input signal.

Although the LIDAR system is disclosed as using complex signals such as the complex data signal, the LIDAR system can also use real signals. As a result, the mathematical transform can be a real transform and the components associated with the generation and use of the quadrature components can be removed from the LIDAR system. As a result, the LIDAR system can use a single signal combiner. Additionally, or alternately, a single light sensor can replace each of the balanced detectors.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
a LIDAR system having a semiconductor chip with a lateral side between a top side and a bottom side, the lateral side including a curved portion; and
the semiconductor chip including a slab waveguide with a facet defined by the curved portion of the lateral side of the semiconductor chip, the semiconductor chip being configured to direct outgoing LIDAR signals through the slab waveguide such that the outgoing LIDAR signal exits the slab waveguide through the curved portion of the lateral side.

2. The system of claim 1, wherein the lateral side is curved in a plane that is parallel to the bottom of the semiconductor chip.

3. The system of claim 1, wherein the semiconductor chip includes a substrate and is configured such that the lateral side of the semiconductor chip includes a lateral side of the substrate, the curved portion of the lateral side being positioned above the lateral side of the substrate with the curved portion of the lateral side being spaced back from the lateral side of the substrate.

4. The system of claim 1, wherein the semiconductor chip includes a reflective optical grating configured to reflect the outgoing LIDAR signal such that the outgoing LIDAR signal travels through the slab waveguide and exits the slab waveguide through the curved portion of the lateral side.

5. The system of claim 4, wherein the reflective optical grating is an echelle grating.

6. The system of claim 4, wherein the optical grating is configured such that a direction that the outgoing LIDAR signal travels away from the semiconductor chip changes in response to a change in a wavelength channel carried by the outgoing LIDAR signal.

7. The system of claim 4, wherein the semiconductor chip includes multiple alternate waveguides that are each configured to output the outgoing LIDAR signal such that the outgoing LIDAR signal travels from any one of the alternate waveguides to the curved portion of the lateral side.

8. The system of claim 7, wherein the curved portion of the lateral side is configured such that an angle of incidence of a central ray of the outgoing LIDAR signal on the curved portion of the lateral side changes in response to a change in a selection of the alternate waveguides that outputs the outgoing LIDAR signal.

9. The system of claim 7, wherein the curved portion of the lateral side is configured such that a direction that the outgoing LIDAR signal travels away from the semiconductor chip changes in response to a change in a selection of the alternate waveguides that outputs the outgoing LIDAR signal.

10. The system of claim 7, wherein the semiconductor chip includes a curved reflecting surface configured to receive the outgoing LIDAR signal from the alternate waveguides and a direction that the outgoing LIDAR signal travels away from the reflective surface changes in response to a change in a selection of the alternate waveguides that outputs the outgoing LIDAR signal.

11. The system of claim 10, wherein the reflective surface includes an optical grating configured such that a direction that a direction that the outgoing LIDAR signal travels away from the semiconductor chip changes in response to a change in a wavelength channel carried by the outgoing LIDAR signal.

12. The system of claim 11, wherein the curved portion of the lateral side is configured such that a direction that the outgoing LIDAR signal travels away from the semiconductor chip changes in response to the change in the wavelength channel carried by the outgoing LIDAR signal.

13. The system of claim 11, wherein the slab waveguide extends from the alternate waveguides to the reflecting surface and from the reflecting surface to the curved portion of the lateral side.

14. The system of claim 11, wherein the semiconductor chip includes a lens, and the slab waveguide extends from the lens to the curved portion of the lateral side.

15. The system of claim 14, wherein a region of the sab waveguide through which the outgoing LIDAR signal travels has an index of refraction that is different from the index of refraction of the lens.

16. The system of claim 14, the semiconductor chip includes a reflective optical grating configured to reflect the outgoing LIDAR signal such that the outgoing LIDAR signal travels through a second slab waveguide to the lens and from the lens to the curved portion of the lateral side.

17. The system of claim 7, wherein the semiconductor chip includes multiple preliminary alternate waveguides that are each configured to guide a different preliminary outgoing LIDAR signal,
the semiconductor chip including amplifiers, each of the amplifiers being configured to receive one of the preliminary outgoing LIDAR signals from a different one of the preliminary alternate waveguides, each of the amplifiers configured to output a LIDAR signal such that the LIDAR signal includes light from the preliminary outgoing LIDAR signal received by the amplifier; and
each of the alternate waveguides being configured to receive the LIDAR signal output from a different one of the amplifiers;
electronics configured to operate the amplifiers such that one of the amplifiers serve as an active amplifier and one or more of the amplifiers each serves as inactive amplifier, the LIDAR signal output from the active amplifier being the outgoing LIDAR signal and any outgoing LIDAR signal output from one of the inactive amplifiers being an inactive outgoing LIDAR signal.

18. The system of claim 1, wherein the curved portion of the lateral side has a shape that increases collimation of the outgoing LIDAR signal.

19. The system of claim 1, wherein the LIDAR system is configured such that an incoming LIDAR signal enters the semiconductor chip through the curved portion of the lateral side, the incoming LIDAR signal including light from the outgoing LIDAR signals.
